(19) United States
(12) Patent Application Publication
(10) Pub. No.: US 2003/0184811 A1
(43) Pub. Date: Oct. 2, 2003

(54) Automated system for image archiving

(76) Inventor: John Overton, Chicago, IL (US)

Correspondence Address: BRINKS HOFER GILSON & LIONE, P.O. BOX 10395, CHICAGO, IL, 60611, US

(21) Appl. No.: 10/118,588

(22) Filed: Apr. 8, 2002

Related U.S. Application Data
(63) Continuation of application No. 09/503,441, filed on Feb. 14, 2000, now abandoned.
Application No. 09/503,441 is a continuation-in-part of application No. 09/111,896, filed on Jul. 8, 1998, now abandoned.
(60) Provisional application No. 60/153,709, filed on Sep. 14, 1999.

(51) Int. Cl. H04N 1/407

(52) U.S. Cl. 358/3.27

(57) ABSTRACT

A method for producing universal object tracking implementations. This invention provides a functional implementation, from which any object-producing device can construct automatically generated archival enumerations. This implementation uses an encoding schemata based on location numbers, object numbers, and parent numbers. Location numbers encode information about logical sequence in the archive, object numbers encode information about the physical attributes of an object, and parent numbers record the conception date and time of a given object's parent. Parent-child relations are algorithmically derivable from location and parent number relationships, thus providing fully recoverable, cumulative object lineage information. Encoding schemata are optimized for use with all current 1, 2, and 3 dimensional barcode symbologies to facilitate data transportation across disparate technologies (e.g., imaging devices, card readers/producers, printers, medical devices). The implemented encoding schemata of this invention supports all manner of object forming devices such as image forming devices, medical devices and computer generated objects.

### REFERENCE TO RELATED APPLICATION

This application is a continuation in part of co-pending application Ser. No.09/111,896 filed Jul. 8, 1998 entitled “System and Method for Establishing and Retrieving Data Based on Global Indices” and application No. 60/153,709 filed Sep. 13, 1999 entitled “Simple Data Transport Protocol Method and Apparatus” from which priority is claimed.

### FIELD OF INVENTION

This invention relates generally to archive, documentation and location of objects and data. More particularly this invention is a universal object tracking system wherein generations of objects which may be physical, electronic, digital, data and images can be related one to another and to original objects that contributed to a object without significant user intervention.

### BACKGROUND OF THE INVENTION

Increasingly, images of various types are being used in a wide variety of industrial, digital, medical, and consumer uses. In the medical field, telemedicine has made tremendous advances that now allow a digital image from some medical sensor to be transmitted to specialists who have the requisite expertise to diagnose injury and disease at locations remote from where the patient lies. However, it can be extremely important for a physician, or indeed any other person to understand how the image came to appear as it does. This involves a knowledge of how the image was processed in order to reach the rendition being examined. In certain scientific applications, it may be important to “back out” the effect of a particular type of processing in order to more precisely understand the appearance of the image when first made.

Varieties of mechanisms facilitate storage and retrieval of archival information relating to images. However, these archival numbering and documentation schemes suffer from certain limitations. For example, classificatory schemata are used to facilitate machine sorting of information about a subject (“subject information”) according to categories into which certain subjects fit. Additionally tracking information, that is, information concerning where the image has been or how the image was processed, is also used together with classificatory schemata.

However, relying on categorizing schemata is inefficient and ineffective. On the one hand, category schemata that are limited in size (i.e. number of categories) are convenient to use but insufficiently comprehensive for large-scale applications, such as libraries and national archives. Alternatively if the classificatory schemata is sufficiently comprehensive for large-scale applications, it may well be far too complicated, and therefore inappropriate for small scale applications, such as individual or corporate collections of image data.

It is also an approach to provide customizable enumeration strategies to narrow the complexity of large-scale systems and make them discipline specific. Various archiving schemes are developed to suit a particular niche or may be customizable for a niche. This is necessitated by the fact that no single solution universally applies to all disciplines, as noted above. However, the resulting customized archival implementation will differ from, for example, a medical image to a laboratory or botanical image archive. The resulting customized image archive strategy may be very easy to use for that application but will not easily translate to other application areas.

Thus, the utility provided by market niche image archiving software simultaneously makes the resulting applications not useful to a wide spectrum of applications. For example, tracking schemata that describes art history categories might not apply to high-tech advertising.

Another type of archival mechanism suffering from some of the difficulties noted above is equipment-specific archiving. In this implementation a particular type of image device, such as a still camera, a video camera, a digital scanner, or other form of imaging means has its own scheme for imprinting or recording archival information relating to the image that is recorded. This is compounded when an image is construed as a data object(s) such as a collection of records related to a given individual, distributed across machines and databases. In the case with distributed data tracking, records (represented as images) may necessarily exist on multiple machines of the same type as well as multiple types of machines.

Thus, using different image-producing devices in the image production chain can cause major problems. For example, mixing traditional photography (with its archive notation) with digital touch-up processing (with its own different archive notation). Further, equipment-specific archive schemes do not automate well, since multiple devices within the same archive may use incompatible enumeration schemata.

Certain classification approaches assume single device input. Thus, multiple devices must be tracked in separate archives, or are tracked as archive exceptions. This makes archiving maintenance more time consuming and inefficient. For example, disciplines that use multiple cameras concurrently, such as sports photography and photo-journalism, confront this limitation.

Yet other archive approaches support particular media formats, but not multiple media formats simultaneously occurring in the archive. For example, an archive scheme may support conventional silver halide negatives but not video or digital media within the same archive.

Thus, this approach fails when tracking the same image across different media formats, such as tracking negative, transparency, digital, and print representation of the same image.

Yet another archive approach may apply to a particular state of the image, as the initial or final format, but does not apply to the full life-cycle of all images. For example, some cameras time- and date-stamp negatives, while database software creates tracking information after processing. While possibly overlapping, the enumeration on the negatives differs from the enumeration created for archiving. In another example, one encoding may track images on negatives and another encoding may track images on prints. However, such a state-specific approach makes it difficult automatically to track image histories and lineages across all phases of an image's life-cycle, such as creation, processing, editing, production, and presentation. Similarly, when used to track data such as that occurring in distributed databases, such a system does not facilitate relating all associated records in a given individual's personal record archive.

Thus, tracking information that uses different encoding for different image states is not particularly effective since maintaining multiple enumeration strategies creates potential archival error, or at a minimum, will not translate well from one image form to another.

Some inventions that deal with recording information about images have been the subject of U.S. patents in the past. U.S. Pat. No. 5,579,067 to Wakabayashi describes a “Camera Capable of Recording Information.” This system provides a camera which records information into an information recording area provided on the film that is loaded in the camera. If information does not change from frame to frame, no information is recorded. However, this invention does not deal with recording information on subsequent processing.

U.S. Pat. No. 5,455,648 to Kazami was granted for a “° Film Holder or for Storing Processed Photographic Film.” This invention relates to a film holder which also includes an information holding section on the film holder itself. This information recording section holds electrical, magnetic, or optical representations of film information. However, once the information is recorded, it is to used for purposes other than to identify the original image.

U.S. Pat. No. 5,649,247 to Itoh was issued for an “Apparatus for Recording Information of Camera Capable of Optical Data Recording and Magnetic Data Recording.” This patent provides for both optical recording and magnetic recording onto film. This invention is an electrical circuit that is resident in a camera system which records such information as aperture value, shutter time, photo metric value, exposure information, and other related information when an image is first photographed. This patent does not relate to recording of subsequent operations relating to the image.

U.S. Pat. No. 5,319,401 to Hicks was granted for a “Control System for Photographic Equipment.” This invention deals with a method for controlling automated photographic equipment such as printers, color analyzers, film cutters. This patent allows for a variety of information to be recorded after the images are first made. It mainly teaches methods for production of pictures and for recording of information relating to that production. For example, if a photographer consistently creates a series of photographs which are off center, information can be recorded to offset the negative by a pre-determined amount during printing. Thus the information does not accompany the film being processed but it does relate to the film and is stored in a separate database. The information stored is therefore not helpful for another laboratory that must deal with the image that is created.

U.S. Pat. No. 5,193,185 to Lanter was issued for a “Method and Means for Lineage Tracing of a Spatial Information Processing and Database System.”. This Patent relates to geographic information systems. It provides for “parent” and “child” links that relate to the production of layers of information in a database system. Thus while the this patent relates to computer-generated data about maps, it does not deal with how best to transmit that information along a chain of image production.

U.S. Pat. No. 5,008,700 to Okamoto was granted for a “Color Image Recording Apparatus using Intermediate Image Sheet.” This patent describes a system, where a bar code is printed on the image production media which can then be read by an optical reader. This patent does not deal with subsequent processing of images which can take place or recording of information that relates to that subsequent processing.

U.S. Pat. No. 4,728,978 was granted to Inoue for a “Photographic Camera.” This patent describes a photographic camera which records information about exposure or development on an integrated circuit card which has a semiconductor memory. This card records a great deal of different types of information and records that information onto film. The information which is recorded includes color temperature information, exposure reference information, the date and time, shutter speed, aperture value, information concerning use of a flash, exposure information, type of camera, film type, filter type, and other similar information. The patent claims a camera that records such information with information being recorded on the integrated circuit court. There is no provision for changing the information or recording subsequent information about the processing of the image nor is there described a way to convey that information through many generations of images.

Thus a need exists to provide a uniform tracking mechanism for any type of image, using any type of image-producing device, which can describe the full life-cycle of an image and which can translate between one image state and another and between one image forming mechanism and another. Such a mechanism should apply to any type of object, relationship, or data that can be described as an image.

### SUMMARY OF THE INVENTION

It is therefore an object of the present invention to create an archival tracking method that includes relations, descriptions, procedures, and implementations for universally tracking objects, entities, relationships, or data able to be described as images.

It is a further object of the present invention to create a tracking method capable of describing any object, entity, or relationship or data that can be described as an image of the object, entity, relationship or data.

It is a further object of the present invention to create an encoding schemata that can describe and catalogue any image produced on any media, by any image producing device, that can apply to all image producing disciplines and objects, entities, relationships, or data able to be described as images for corresponding disciplines.

It is a further object of the present invention to implement to archival scheme on automated data processing means that exist within image producing equipment.

It is a further object of the present invention to apply to all image-producing devices including devices producing objects, entities, relationships, or data that is able to be described as images.

It is a further object of the present invention to support simultaneous use of multiple types of producing devices including devices producing objects, entities, relationships, or data that is able to be described as images.

It is a further object of the present invention to support simultaneous use of multiple producing devices of the same type.

It is a further object of the present invention to provide automatic parent-child encoding.

It is a further object of the present invention to track image lineages and family trees.

It is a further object of the present invention to provide a serial and chronological sequencing scheme that uniquely identifies all objects, entities, relationships, or data that is able to be described as images in an archive.

It is a further object of present invention to provide an identification schemata that describes physical attributes of all objects, entities, relationships, or data that is able to be described as images in an archive.

It is a further object of the present invention to separate classificatory information from tracking information.

It is a further object of the present invention to provide an enumeration schemata applicable to an unlimited set of media formats used in producing objects, entities, relationships, or data that is able to be described as images.

It is a further object of the present invention to apply the archival scheme to all stages of life-cycle, from initial formation to final form of objects, entities, relationships, or data that is able to be described as images.

It is a further object of the present invention to create self-generating archives, through easy assimilation into any device including devices producing objects, entities, relationships, or data that is able to be described as images.

It is a further object of the present invention to create variable levels of tracking that are easily represented by current and arriving barcode symbologies, to automate data transmission across different technologies (e.g., negative to digital to print).

These and other objects of the present invention will become clear to those skilled in the art from the description that follows.

### BRIEF DESCRIPTION OF THE INVENTION

The present invention is a universal object tracking method and apparatus for tracking and documenting objects, entities, relationships, or data that is able to be described as images through their complete life-cycle, regardless of the device, media, size, resolution, etc., used in producing them.

Specifically, the automated system for image archiving (“ASIA”) encodes, processes, and decodes numbers that characterize objects, entities, relationships, or data that is able to be described as images and related data. Encoding and decoding takes the form of a 3-number association: 1) location number (serial and chronological location), 2) image number (physical attributes), and 3) parent number (parent-child relations).

### Flexibility of Encoding

A key aspect of the present inventions is that any implementation of the system and method of the present invention is interoperable with any other implementation. For example, a given implementation may use the encoding described herein as complete database record describing a multitude of images. Another implementation may use the encoding described herein for database keys describing medical records. Another implementation may use the encoding described herein for private identification. Still another may use ASIA encoding for automobile parts-tracking. Yet all such implementations will interoperate.

This design of the present invention permits a single encoding mechanism to be used in simple devices as easily as in industrial computer systems.

### Parent-Child Relations

The system and method of the present invention includes built-in “parent-child” encoding that is capable of tracking parent-child relations across disparate producing mechanisms. This native support of parent-child relations is included in the encoding structure, and facilitates tracking diverse relations, such as record transactions, locations of use, image derivations, database identifiers, etc. Thus, it is a function of the present invention that parent-child relations are used to track identification of records from simple mechanisms, such as cameras and TVs through diverse computer systems.

### Uniqueness

The system and method of the present invention possesses uniqueness that can be anchored to device production. Thus the encoding described herein can bypass the problems facing “root-registration” systems (such as facing DICOM in the medical X-ray field). Additionally, the encoding described herein can use a variety of ways to generate uniqueness. Thus it applies to small, individual devices (e.g. cameras), as well as to fully automated, global systems (e.g., universal medical records).

In global systems, uniqueness resembles Open Software Foundation's DCE UUIDs (and Microsoft GUIDs), except that the encoding described herein includes a larger logical space. Such design facilitates interoperability across wide domains of application: e.g., from encoding labels for automatically generated photographic archival systems, to secure identification, to keys for distributed global database systems. This list is not meant as a limitation and is only illustrative in nature. Other applications will be apparent to those skilled in the art from a review of the specification herein.

### Media Traversability

The encoding described herein applies equally well to “film” and “filmless” systems, or other such distinctions. This permits the same encoding mechanism for collections of records produced on any device, not just digital devices. Tracking systems can thus track tagged objects as well as digital objects. Similarly, since the encoding mechanism is anchored to device-production, supporting a new technology is as simple as adding a new device. This in turn permits the construction of comprehensive, automatically generated tracking mechanism to be created and maintained, which require no human effort aside from the routine usage of the devices.

Using the encoding described herein, a simple implementation of the system requires less than 2K of code space. A more complex industrial implementation requires less than 200K of code space.

### DEFINITIONS

The following definitions apply throughout this specification:

Field: A record in an ASIA number.

Component: A set of fields grouped according to general functionality.

Location component: A component that identifies logical location.

Parent component: A component that characterizes a relational status between an object and it's parent.

Image component: A component that identifies physical attributes.

Schema: A representation of which fields are present in length and encoding.

Length: A representation of the lengths of fields that occur in encoding.

Encoding: Data, described by length and encoding.

### BRIEF DESCRIPTION OF THE FIGURES

FIG. 1. illustrates an overview of the present invention

FIG. 1A. illustrates the overarching structure organizing the production of system numbers

FIG. 1B. illustrates the operation of the system on an already existing image

FIG. 2 illustrates the formal relationship governing encoding and decoding

FIG. 3 illustrates the encoding relationship of the present invention

FIG. 4 illustrates the relationships that characterize the decoding of encoded information

FIG. 5 illustrates the formal relations characterizing all implementations of the invention

FIG. 6 illustrates the parent-child encoding of the present invention in example form

FIG. 7 illustrates the processing flow of ASIA

### DETAILED DESCRIPTION OF THE INVENTION

The present invention is a method and apparatus for formally specifying relations for constructing image tracking mechanisms, and providing an implementation that includes an encoding schemata for images regardless of form or the equipment on which the image is produced.

The numbers assigned by the system and method of the present invention are automatically generated unique identifiers designed to uniquely identify objects within collections thereby avoiding ambiguity. When system numbers are associated with objects they are referred to herein as “tags.” Thus, the expression “system tag encoding” refers to producing and associating system numbers with objects.

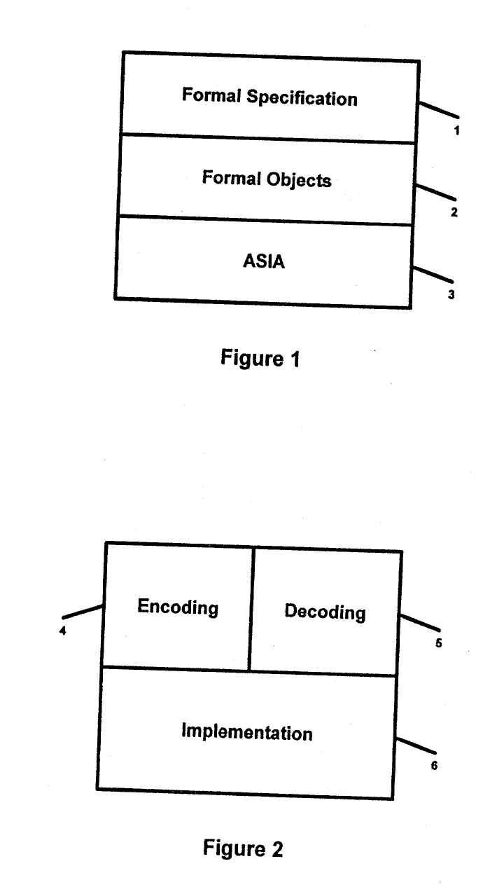

FIG. 1A illustrates the overarching structure organizing the production of system numbers.

The present invention is organized by three “components”: “Location,” “Image,” and “Parent.” These heuristically group 18 variables are called “fields.” Fields are records providing data, and any field (or combination of fields) can be encoded into an system number. The arrow ( ) labeled ‘Abstraction’ points in the direction of increasing abstraction. Thus, the Data Structure stratum provides the most concrete representation of the system and method of the present invention, and the Heuristics stratum provides the most abstract representation of the system of present invention.

As noted above, the system and method of the present invention comprises and organizational structure includes fields, components, and relations between fields and components. The following conventions apply and/or govern fields and components:

Base 16 schema. Base 16 (hex) numbers are used, except that leading ‘0’ characters are excluded in encoding implementations. Encoding implementations MUST strip leading ‘0’ characters in base 16 numbers.

Decoding implementations MUST accept leading ‘0’ characters in base 16 numbers.

UTF-8 Character Set —The definition of “character” in this specification complies with RFC 2279. When ‘character’ is used, such as in the expression “uses any character”, it means “uses any RFC 2279 compliant character”.

Software Sets —ASIA implementations inherit core functionality unless otherwise specified through the image component's set field. See Section 2.2.3.3 Image for details about set.

Representation Constraints —Certain constraints MAY be imposed on field representations, such as the use of integers for given fields in given global databases. This will be handled on a per domain basis, such as by the definition of a given global database. When needed, given applications MAY need to produce multiple ASIA numbers for the same item, to participate in multiple databases.

### Fields

A field is a record in an ASIA number. Using any field (or collection of fields) MAY (1) distinguish one from another ASIA number, and (2) provide uniqueness for a given tag in a given collection of tags.

ASIA compliance requires the presence of any field, rather than any component. Components heuristically organize fields.

### Components

A component is a set of fields grouped according to general functionality. Each component has one or more fields. ASIA has three primary components: location, image, and parent.

TABLE 1
Components

| Component | Description |
|---|---|
| Location | Logical location |
| Parent | Parent information |
| Image | Physical attributes |

Referring to Table 1 (above) Components are illustrated. This table 1 lists components and their corresponding description. The following sections specifically describe components and their corresponding fields.

A tag's location (see Table 1) component simply locates an ASIA number within a given logical space, determined by a given application. The characteristics of the location component are illustrated below in Table 2.

TABLE 2
Location

| Field | Description | Representation |
|---|---|---|
| Generation | Family relation depth | Uses any character |
| Sequence | Enumeration of group | Uses any character |
| Time | Date/time made | Uses any character |
| Author | Producing agent | Uses any character |
| Device | Device used | Uses any character |
| Unit | Enumeration in group | Uses any character |
| Random | Nontemporal uniqueness | Uses any character |
| Custom | Reserved for applications | Uses any character |

Table 2 Location (above) lists location fields, descriptions, and representation specifications.

The following definitions apply to component fields.

generation —identifies depth in family relations, such as parent-child relations. For example, ‘1’ could represent “first generation”, ‘2’ could represent “second generation”, and so forth.

sequence —serially enumerates a group among groups. For example, sequence could be the number of a given roll of 35 mm film in a photographer's collection.

time —date-stamps a number. This is useful to distinguish objects of a given generation. For example, using second enumeration could (“horizontally”) distinguish siblings of a given generation.

Author —identifies the producing agent or agents. For example, a sales clerk, equipment operator, or manufacturer could be authors.

device —identifies a device within a group of devices. For example, cameras in a photographer's collection, or serial numbers in a manufacturer's equipment-line, could receive device assignments.

unit —serially enumerates an item in a group. For example, a given page in a photocopy job, or a frame number in a roll of film, could be units.

random —resolves uniqueness. For example, in systems using time for uniqueness, clock resetting can theoretically produce duplicate time-stamping. Using random can prevent such duplicate date-stamping.

custom —is dedicated for application-specific functionality not natively provided by ASIA, but needed by a given application.

The following notes apply to the system of the present invention.

Uniqueness —ASIA often generates uniqueness through time, nit, and random.

Inplementation needs will determine which field or combination of fields are used to guarantee uniqueness.

time —ASIA uses ISO 8601:1988 date-time marking, and optional fractional time. Date-stamping can distinguish tags within a generation. In such cases, time granularity MUST match or exceed device production speed or 2 tags can receive the same enumeration. For example, if a photocopy machine produces 10 photocopies per minute, time granularity MUST at least use 6 second time-units, rather than minute time-units. Otherwise, producing 2 or more photocopies could produce 2 or more of the same time-stamps, and therefore potentially also 2 or more of the same ASIA numbers.

Author —Multiple agents MUST be separated with “,” (comma). random —ASIA uses random as one of three commonly used mechanisms to generate uniqueness (see uniqueness, above). It is particularly useful for systems using time which may be vulnerable to clock resetting. Strong cryptographic randomness is not required for all applications.

### The Parent

A tag's parent component characterizes an object's parent. This is an system number, subject to the restrictions of any system number as described herein. Commonly, this contains time, random, or unit. The following notes apply:

representation constraints

The representation constraints for the parent field are those of the database appropriate to it. Representation constraints MAY differ between the parent field and the system number of which the field is a part.

### Image

A tag's image component describes the physical characteristics of an object. For example, an image component could describe the physical characteristics of a plastic negative, steel part, silicon wafer, etc. Table 3 Image lists and illustrates image component fields and their general descriptions.

TABLE 3
Image

| Field | Description | Representation |
|---|---|---|
| Category | Characterizing domain | Uses any character |
| Size | Dimensionality | Uses any character |
| Bit | Dynamic range (“bit depth”) | Uses any character |
| Push | Exposure | Uses any character |
| Media | Media representation | Uses any character |
| Set | Software package | Uses any character |
| Resolution | Resolution | Uses any character |
| Stain | Chromatic representation | Uses any character |
| Format | Object embodiment | Uses any character |

The following definitions describes component fields.

category: identifies characterizing domain. For example, in photography category could identify “single frame”, to distinguish single frame from motion picture photography.

size: describes object dimensionality. For example, size could describe an 8×11 inch page, or 100×100×60 micron chip, etc.

bit: dynamic range ( “bit depth”). For example, bit could describe a “24 bit” dynamic range for a digital image.

Push: records push or pull. For example, push could describe a “1.3 stop over-exposure” for a photographic image.

Media: describes the media used to represent an object. For example, media could be “steel” for a part, or “Kodachrome” for a photographic transparency.

Set: identifies a software rendering and/or version. For example, set could be assigned to “HP: 1.3”.

Resolution: describes resolution of an object. For example, resolution could represent dots-per-inch in laser printer output.

Stain: describes chromatic representation. For example, stain could represent “black and white” for a black and white negative.

Format: describes object embodiment. For example, format could indicate a photocopy, negative, video, satellite, etc. representation.

The following notes apply to the image data.

set —when nonempty, permits the remapping of any field value. When empty, core functionality defaults are active. To add revisions, the delimiter “:” (colon) is added to a given root. For example, to add revision number “1.3” to root “HP”, set would be “HP: 1.3”.

While the functionality of components and fields. Have been illustrated above, Table 4 (below) assembles these into the formal organization from which the the system data structure of the present invention is derived. This ordering provides the basis for the base 16 representation of the schema.

TABLE 4
Fields

| Component | Field | | | | | | | | |
|---|---|---|---|---|---|---|---|---|---|
| Location | 1 | 2 | 3 | 4 | 5 | 6 | 7 | 8 | |
| | Generation | sequence | time | author | device | unit | random | custom | |
| Parent | 9 | | | | | | | | |
| | parent | | | | | | | | |
| Image | 10 | 11 | 12 | 13 | 14 | 15 | 16 | 17 | 18 |
| | Category | size | bit | push | media | set | resolution | stain | format |

This Table 4 (above) assembles these data into the formal organization from which ASIA data structure is derived. This ordering provides the basis for the base 16 representation of the schema.

Table 5 (below) illustrates the data structure used to encode fields into an ASIA tag. An ASIA tag has five parts: schema, :, length, :, encoding.

TABLE 5
Data Structure

| | | | | |
|---|---|---|---|---|
| Part¹ | Part² | Part³ | Part⁴ | Part⁵ |
| Schema | : | length | : | encoding |

Each “part” has one or more “elements,” and “elements” have 1-to-1 correspondences across all “parts.” Consider the following definitions for Table 5.

Schema —An arbitrarily long base 16 integer, whose bits represent the presence of component fields represented in length and encoding, and listed in Table 4. If the least significant bit is set the field 1 is encoded.

: —The opening delimiter separating schema and length.

length —Comma separated lengths for the fields represented in encoding, whose presence is indicated in schema.

: —The closing delimiter separating length and encoding.

encoding —A concatenated list of fields instantiating the elements indicated by schema and determined by length.

It is helpful to illustrate an ASIA number. Consider example (1) (below):

1C:15,2,1:19981211T112259GE1

In this ASIA number, schema is “1C”, a hex (base 16) integer (stripped of leading zeros) indicating the presence of three fields (see Table 4): time, author, device. In turn, length is ‘15,2,1’, indicating that the first field is 15 long, the second 2 long, and the third 1 long. The encoding is ‘1998121 1T112259GE1’, and includes the fields identified by schema and determined by length. The encoding has 3 fields: ‘19981211 T112259’ (time), ‘GE’ (author), and ‘1’ (device).

Table 6 Location, (below) illustrates the fields and the description of the filed used to specify “location.”

TABLE 6
Location

| Field | Description |
|---|---|
| Generation | Uses any integer. |
| Sequence | Uses any integer. |
| Time | See “time” (above) |
| Author | Uses any character. |
| Device | Uses any character. |
| Unit | Uses any integer. |
| Random | Uses any integer. |
| Custom | Uses any character. |

parent —uses the definition of the location component's time field (see Table 6 above.).

Table 7: Image, (below) illustrates the fields and description associated with “image.”

TABLE 7
Image

| Field | Description |
|---|---|
| category | See Table 8 Categories |
| size | See Table 9 Size/res. Syntax |
| | See Table 10 Measure |
| | See Table 11 Size examples |
| bit | See Table 12 Bit |
| push | See Table 13 Push |
| media | See Table 14 Reserved media slots |
| | See Table 15 Color transparency film |
| | See Table 16 Color negative film |
| | See Table 17 Black & white film |
| | See Table 18 Duplicating & internegative film |
| | See Table 19 Facsimile |
| | See Table 20 Prints |
| | See Table 21 Digital |
| set | See Table 22 Software Sets |
| resolution | See Table 9 Size/res. Syntax |
| | See Table 10 Measure |
| | See Table 23 Resolution examples |
| stain | See Table 24 Stain |
| format | See Table 25 Format |

The category field has 2 defaults as noted in Table 8 (below)..

TABLE 8
Categories

| Literal | Description |
|---|---|
| S | Single frame |
| M | Motion picture |

The size field has 2 syntax forms, indicated in Table 9 Size/res. Syntax (below).

Table 10 Measure (below) provides default measure values that are used in Table 9.

Table 11 Size examples provides illustrations of the legal use of size. Consider the following definitions.

dimension —is a set of units using measure.

measure —is a measurement format.

n{+}—represents a regular expression, using 1 or more numbers (0-9).

Ic{*}—represents a regular expression beginning with any single letter (a-z; A-Z), and continuing with any number of any characters.

X-dimension —is the X-dimension in an X-Y coordinate system, subject to measure.

Y-dimension —is the Y-dimension in an X-Y coordinate system, subject to measure.

X —is a constant indicating an X-Y relationship.

TABLE 9
Size/res. syntax

| Category | Illustration | | | |
|---|---|---|---|---|
| Names | Dimension | | | measure |
| Type 1 | n{+} | | | lc{*} |
| Names | X-dimension | X | Y-dimension | measure |
| Type 2 | n{+} | X | n{+} | lc{*} |

Table 10 illustrates default values for measure. It does not preclude application-specific extensions.

TABLE 10
Measure

| Category | Literal | Description | |
|---|---|---|---|
| Shared | DI | Dots per inch | (dpi) |
| | DE | Dots per foot | (dpe) |
| | DY | Dots per yard | (dpy) |
| | DQ | Dots per mile | (dpq) |
| | DC | Dots per centimeter | (dpc) |
| | DM | Dots per millimeter | (dpm) |
| | DT | Dots per meter | (dpt) |
| | DK | Dots per kilometer | (dpk) |
| | DP | Dots per pixel | (dpp) |
| | N | Micron(s) | |
| | M | Millimeter(s) | |
| | C | Centimeter(s) | |
| | T | Meter(s) | |
| | K | Kilometer(s) | |
| | I | Inch(s) | |
| | E | Foot/Feet | |
| | Y | Yard(s) | |
| | Q | Mile(s) | |
| | P | Pixel(s) | |
| | L | Line(s) | |
| | R | Row(s) | |
| | O | Column(s) | |
| | B | Column(s) & row(s) | |
| | . . . | etc. | |
| Size Unique | F | Format | |
| | S | Sheet | |
| | . . . | etc. | |
| Res. Unique | S | ISO | |
| | . . . | etc. | |

Table 11 entitled “Size Examples” (below) illustrates the Syntax, literal, description and measures associated with various sizes of images. This listing is not meant as a limitation but is illustrative only. As other sizes of images are created, these too will be able to be specified by the system of the present invention.

TABLE 11
Size examples

| Syntax | Literal | Description | Measure |
|---|---|---|---|
| Type 1 | 135F | 35 mm | format |
| | 120F | Medium | format |
| | 220F | Full | format |
| | 4 × 5F | 4 × 5 | format |
| | . . . | . . . | etc. |
| Type 2 | 9 × 14C | 9 × 14 | centimeter |
| | 3 × 5I | 3 × 5 | inch |
| | 4 × 6I | 4 × 6 | inch |
| | 5 × 7I | 5 × 7 | inch |
| | 8 × 10I | 8 × 10 | inch |
| | 11 × 14I | 11 × 14 | inch |
| | 16 × 20I | 16 × 20 | inch |
| | 20 × 24I | 20 × 24 | inch |
| | 24 × 32I | 24 × 32 | inch |
| | 24 × 36I | 24 × 36 | inch |
| | 32 × 40I | 32 × 40 | inch |
| | 40 × 50I | 40 × 50 | inch |
| | 50 × 50I | 50 × 50 | inch |
| | 40 × 50P | 40 × 50 | pixels |
| | 100 × 238P | 100 × 238 | pixels |
| | 1024 × 1280P | 1024 × 1280 | pixels |
| | A1S | 59.4 × 84.0 cm | sheet |
| | A2S | 42.0 × 59.4 cm | sheet |
| | A3S | 29.7 × 42.0 cm | sheet |
| | A4S | 21.0 × 29.7 cm | sheet |
| | A5S | 14.85 × 21.0 cm | sheet |
| | A6S | 10.5 × 14.85 cm | sheet |
| | A7S | 7.42 × 10.5 cm | sheet |
| | A1RS | 84.0 × 59.4 cm | sheet |
| | A2RS | 59.4 × 42.0 cm | sheet |
| | A3RS | 42.0 × 29.7 cm | sheet |
| | A4RS | 29.7 × 21.0 cm | sheet |
| | A5RS | 21.0 × 14.85 cm | sheet |
| | A6RS | 14.85 × 10.5 cm | sheet |
| | A7RS | 10.5 × 7.42 cm | sheet |
| | B1S | 70.6 × 100.0 cm | sheet |
| | B2S | 50.0 × 70.6 cm | sheet |
| | B3S | 35.3 × 50.0 cm | sheet |
| | B4S | 25.0 × 35.3 cm | sheet |
| | B5S | 17.6 × 25.0 cm | sheet |
| | B6S | 13.5 × 17.6 cm | sheet |
| | B7S | 8.8 × 13.5 cm | sheet |
| | B1RS | 100.0 × 70.6 cm | sheet |
| | B2RS | 70.6 × 50.0 cm | sheet |
| | B3RS | 50.0 × 35.3 cm | sheet |
| | B4RS | 35.3 × 25.0 cm | sheet |
| | B5RS | 25.0 × 17.6 cm | sheet |
| | B6RS | 17.6 × 13.5 cm | sheet |
| | B7RS | 13.5 × 8.8 cm | sheet |
| | C1S | 64.8 × 91.6 cm | sheet |
| | C2S | 45.8 × 64.8 cm | sheet |
| | C3S | 32.4 × 45.8 cm | sheet |
| | C4S | 22.9 × 32.4 cm | sheet |
| | C5S | 16.2 × 22.9 cm | sheet |
| | C6S | 11.46 × 16.2 cm | sheet |
| | C7S | 8.1 × 11.46 cm | sheet |
| | C1RS | 91.6 × 64.8 cm | sheet |
| | C2RS | 64.8 × 45.8 cm | sheet |
| | C3RS | 45.8 × 32.4 cm | sheet |
| | C4RS | 32.4 × 22.9 cm | sheet |
| | C5RS | 22.9 × 16.2 cm | sheet |
| | C6RS | 16.2 × 11.46 cm | sheet |
| | C7RS | 11.46 × 8.1 cm | sheet |
| | JISS | 18.2 × 25.7 cm | sheet |
| | USS | 8.5 × 11 in | sheet |
| | USRS | 8.5 × 11 in | sheet |
| | LEGALS | 8.5 × 14 in | sheet |
| | EXECUTIVES | 7.25 × 10.5 in | sheet |
| | FOOLSCAPS | 13.5 × 17.0 in | sheet |
| | . . . | . . . | etc. |

Table 12 (below) lists legal values for the bit field.

TABLE 12
Bit

| Literal | Description |
|---|---|
| 8 | 8 bit dynamic range |
| 24 | 24 bit dynamic range |
| . . . | etc. |

Table 13 (below) lists legal values for the push field.

TABLE 13
Push

| Literal | Description |
|---|---|
| +1 | Pushed +1 stops |
| −.3 | Pulled −.3 stops |
| . . . | etc. |

Values of media (illustrated in Table 14 below) are keyed to the format field, thus permitting reuse of given abbreviations for multiple contexts. The mapping of dependencies is illustrated in Table 25..

TABLE 14
Reserved media slots

| Reserved For | Literal | Description |
|---|---|---|
| Unknown | XXXX | Unknown film |
| Specification | UR0 | For future use |
| | UR1 | ″ |
| | UR2 | ″ |
| | UR3 | ″ |
| | UR4 | ″ |
| | UR5 | ″ |
| | UR6 | ″ |
| | UR7 | ″ |
| | UR8 | ″ |
| | UR9 | ″ |
| User | UX0 | Customization |
| | UX1 | ″ |
| | UX2 | ″ |
| | UX3 | ″ |
| | UX4 | ″ |
| | UX5 | ″ |
| | UX6 | ″ |
| | UX7 | ″ |
| | UX8 | ″ |
| | UX9 | ″ |

Table 15 “Color Transparency Filem” (below) illustrates the company. Literal and description field available for existing transparency films. As new transparency flms emerge, these too can be accommodated by the present invention.

TABLE 15
Color transparency film

| Company | Literal | Description |
|---|---|---|
| Agfa | AASC | Agfa Agfapan Scala Reversal (B&W) |
| | ACRS | Agfa Agfachrome RS |
| | ACTX | Agfa Agfachrome CTX |
| | ARSX | Agfa Agfacolor Professional RSX Reversal |
| Fuji | FCRTP | Fuji Fujichrome RTP |
| | FCSE | Fuji Fujichrome Sensia |
| | FRAP | Fuji Fujichrome Astia |
| | FRDP | Fuji Fujichrome Provia Professional 100 |
| | FRPH | Fuji Fujichrome Provia Professional 400 |
| | FRSP | Fuji Fujichrome Provia Professional 1600 |
| | FRTP | Fuji Fujichrome Professional Tungsten |
| | FRVP | Fuji Fujichrome Velvia Professional |
| Ilford | IICC | Ilford Ilfochrome |
| | IICD | Ilford Ilfochrome Display |
| | IICM | Ilford Ilfochrome Micrographic |
| Konica | CAPS | Konica APS JX |
| | CCSP | Konica Color Super SR Professional |
| Kodak | K5302 | Kodak Eastman Fine Grain Release Positive |
| | | Film 5302 |
| | K7302 | Kodak Fine Grain Positive Film 7302 |
| | KA2443 | Kodak Aerochrome II Infrared Film 2443 |
| | KA2448 | Kodak Aerochrome II MS Film 2448 |
| | KE100SW | Kodak Ektachrome Professional E100SW Film |
| | KE100S | Kodak Ektachrome Professional E100S Film |
| | KE200 | Kodak Ektachrome Professional E200 Film |
| | KEEE | Kodak Ektachrome Elite |
| | KEEO100 | Kodak Ektachrome Electronic Output Film 100 |
| | KEEO200 | Kodak Ektachrome Electronic Output Film 200 |
| | KEEO64T | Kodak Ektachrome Electronic Output Film 64T |
| | KEEP | Kodak Ektachrome E Professional |
| | KEES | Kodak Ektachrome ES |
| | KEEW | Kodak Ektachrome EW |
| | KEIR | Kodak Ektachrome Professional Infrared EIR |
| | | Film |
| | KEK | Kodak Ektachrome |
| | KELL | Kodak Ektachrome Lumiere Professional |
| | KELX | Kodak Ektachrome Lumiere X Professional |
| | KEPD | Kodak Ektachrome 200 Professional Film |
| | KEPF | Kodak Ektachrome Professional |
| | KEPH | Kodak Ektachrome Professional P1600 Film |
| | KEPJ | Kodak Ektachrome 320T Professional Film, |
| | | Tungsten |
| | KEPL400 | Kodak Ektachrome Professional 400X Film |
| | KEPL | Kodak Ektachrome 200 Professional Film |
| | KEPL | Kodak Ektachrome Plus Professional |
| | KEPN | Kodak Ektachrome 100 Professional Film |
| | KEPO | Kodak Ektachrome P Professional |
| | KEPR | Kodak Ektachrome 64 Professional |
| | KEPT | Kodak Ektachrome 160T Professional Film, |
| | | Tungsten |
| | KEPY | Kodak Ektachrome 64T Professional Film, |
| | | Tungsten |
| | KETP | Kodak Ektachrome T Professional |
| | KETT | Kodak Ektachrome T |
| | KEXP | Kodak Ektachrome X Professional |
| | KCCR | Kodak Kodachrome |
| | KPKA | Kodak Kodachrome Professional 64 Film |
| | KPKL | Kodak Kodachrome Professional 200 Film |
| | KPKM | Kodak Kodachrome Professional 25 Film |
| | KVSSO279 | Kodak Vericolor Slide Film SO-279 |
| | KVS | Kodak Vericolor Slide Film |
| Polaroid | PPCP | Kodak Professional High Contrast Polychrome |
| Reserved | — | See Table 14 |
| Seattle | SFWS | Seattle Film Works |
| FW | | |
| 3M | TSCS | 3M ScotchColor Slide |
| | TSCT | 3M ScotchColor T slide |

Table 16 (below) illustrates the types of color negative film that can be accommodated by the present invention. Again this list is not meant as a limitation but is illustrative only.

TABLE 16
Color negative film

| Company | Literal | Description |
|---|---|---|
| Agfa | ACOP | Agfa Agfacolor Optima |
| | AHDC | Agfa Agfacolor HDC |
| | APOT | Agfa Agfacolor Triade Optima Professional |
| | APO | Agfa Agfacolor Professional Optima |
| | APP | Agfa Agfacolor Professional Portrait |
| | APU | Agfa Agfacolor Professional Ultra |
| | APXPS | Agfa Agfacolor Professional Portrait XPS |
| | ATPT | Agfa Agfacolor Triade Portrait Professional |
| | ATUT | Agfa Agfacolor Triade Ultra Professional |
| Fuji | FHGP | Fuji Fujicolor HG Professional |
| | FHG | Fuji Fujicolor HG |
| | FNHG | Fuji Fujicolor NHG Professional |
| | FNPH | Fuji Fujicolor NPH Professional |
| | FNPL | Fuji Fujicolor NPL Professional |
| | FNPS | Fuji Fujicolor NPS Professional |
| | FPI | Fuji Fujicolor Print |
| | FPL | Fuji Fujicolor Professional, Type L |
| | FPO | Fuji Fujicolor Positive |
| | FRG | Fuji Fujicolor Reala G |
| | FR | Fuji Fujicolor Reala |
| | FSGP | Fuji Fujicolor Super G Plus |
| | FSG | Fuji Fujicolor Super G |
| | FSHG | Fuji Fujicolor Super HG 1600 |
| | FS | Fuji Fujicolor Super |
| Kodak | K5079 | Kodak Motion Picture 5079 |
| | K5090 | Kodak CF1000 5090 |
| | K5093 | Kodak Motion Picture 5093 |
| | K5094 | Kodak Motion Picture 5094 |
| | KA2445 | Kodak Aerocolor II Negative Film 2445 |
| | KAPB | Kodak Advantix Professional Film |
| | KCPT | Kodak Kodacolor Print |
| | KEKA | Kodak Ektar Amateur |
| | KEPG | Kodak Ektapress Gold |
| | KEPPR | Kodak Ektapress Plus Professional |
| | KGOP | Kodak Gold Plus |
| | KGO | Kodak Gold |
| | KGPX | Kodak Ektacolor Professional GPX |
| | KGTX | Kodak Ektacolor Professional GTX |
| | KPCN | Kodak Professional 400 PCN Film |
| | KPHR | Kodak Ektar Professional Film |
| | KPJAM | Kodak Ektapress Multispeed |
| | KPJA | Kodak Ektapress 100 |
| | KPJC | Kodak Ektapress Plus 1600 Professional |
| | KPMC | Kodak Pro 400 MC Film |
| | KPMZ | Kodak Pro 1000 Film |
| | KPPF | Kodak Pro 400 Film |
| | KPRMC | Kodak Pro MC |
| | KPRN | Kodak Pro |
| | KPRT | Kodak Pro T |
| | KRGD | Kodak Royal Gold |
| | KVPS2L | Kodak Vericolor II Professional Type L |
| | KVPS3S | Kodak Vericolor III Professional Type S |
| | KVP | Kodak Vericolor Print Film |
| Konica | CCIP | Konica Color Impresa Professional |
| | CCSR | Konica SRG |
| Polaroid | POCP | Polaroid OneFilm Color Print |
| Reserved | — | See Table 14 |

Table 17 (below) illustrates a list of black and white film that can be accommodated by the present invention. Again this list is illustrative only and is not meant as a limitation.

TABLE 17
Black & white film

| Company | Literal | Description |
|---|---|---|
| Agfa | AAOR | Agfa Agfapan Ortho |
| | AAPX | Agfa Agfapan APX |
| | APAN | Agfa Agfapan |
| Ilford | IDEL | Ilford Delta Professional |
| | IFP4 | Ilford FP4 Plus |
| | IHP5 | Ilford HP5 Plus |
| | IPFP | Ilford PanF Plus |
| | IPSF | Ilford SFX750 Infrared |
| | IUNI | Ilford Universal |
| | IXPP | Ilford XP2 Plus |
| Fuji | FNPN | Fuji Neopan |
| Kodak | K2147T | Kodak PLUS-X Pan Professional 2147, ESTAR |
| | | Thick Base |
| | K2147 | Kodak PLUS-X Pan Professional 2147, ESTAR |
| | | Base |
| | K4154 | Kodak Contrast Process Ortho Film 4154, |
| | | ESTAR Thick Base |
| | K4570 | Kodak Pan Masking Film 4570, ESTAR Thick |
| | | Base |
| | K5063 | Kodak TRI-X 5063 |
| | KA2405 | Kodak Double-X Aerographic Film 2405 |
| | KAI2424 | Kodak Infrared Aerographic Film 2424 |
| | KAP2402 | Kodak PLUS-X Aerographic II Film 2402, |
| | | ESTAR Base |
| | KAP2412 | Kodak Panatomic-X Aerographic II Film 2412, |
| | | ESTAR Base |
| | KEHC | Kodak Ektagraphic HC |
| | KEKP | Kodak Ektapan |
| | KH13101 | Kodak High Speed Holographic Plate, Type |
| | | 131-01 |
| | KH13102 | Kodak High Speed Holographic Plate, Type |
| | | 131-02 |
| | KHSIET | Kodak High Speed Infrared, ESTAR Thick Base |
| | KHSIE | Kodak High Speed Infrared, ESTAR Base |
| | KHSI | Kodak High Speed Infrared |
| | KHSO253 | Kodak High Speed Holographic Film, |
| | | ESTAR Base SO-253 |
| | KLPD4 | Kodak Professional Precision Line Film LPD4 |
| | KO2556 | Kodak Professional Kodalith Ortho Film 2556 |
| | KO6556 | Kodak Professional Kodalith Ortho Film 6556, |
| | | Type 3 |
| | KPMF3 | Kodak Professional Personal Monitoring Film, |
| | | Type 3 |
| | KPNMFA | Kodak Professional Personal Neutron Monitor |
| | | Film, Type A |
| | KPXE | Kodak PLUS-X Pan Professional, Retouching |
| | | Surface, Emulsion & Base |
| | KPXP | Kodak PLUS-X Pan Professional, Retouching |
| | | Surface, Emulsion |
| | KPXT | Kodak PLUS-X Pan Professional, Retouching |
| | | Surface, Emulsion & Base |
| | KPXX | Kodak Plus-X |
| | KPX | Kodak PLUS-X Pan Film |
| | KREC | Kodak Recording 2475 |
| | KSAF1 | Kodak Spectrum Analysis Film, No. 1 |
| | KSAP1 | Kodak Spectrum Analysis Plate, No. 1 |
| | KSAP3 | Kodak Spectrum Analysis Plate, No. 3 |
| | KSWRP | Kodak Short Wave Radiation Plate |
| | KTMXCN | Kodak Professional T-MAX Black and |
| | | White Film CN |
| | KTMY | Kodak Professional T-MAX |
| | KTMZ | Kodak Professional T-MAX P3200 Film |
| | KTP2415 | Kodak Technical Pan Film 2415, |
| | | ESTAR-AH Base |
| | KTP | Kodak Technical Pan Film |
| | KTRP | Kodak TRI-Pan Professional |
| | KTRXPT | Kodak TRI-X Pan Professional 4164, |
| | | ESTAR Thick Base |
| | KTRXP | Kodak TRI-Pan Professional |
| | KTXP | Kodak TRI-X Professional, Interior Tungsten |
| | KTXT | Kodak TRI-X Professional, Interior Tungsten |
| | KTX | Kodak TRI-X Professional |
| | KVCP | Kodak Verichrome Pan |
| Konica | CIFR | Kodak Infrared 750 |
| Polaroid | PPGH | Konica Polagraph HC |
| | PPLB | Polaroid Polablue BN |
| | PPPN | Polaroid Polapan CT |
| Reserved | — | See Table 14 |

Referring to Table 18 (below) Duplicating and Internegative Films are illustrated. Again this list is for illustrative purposes only and is not meant as a limitation.

TABLE 18
Duplicating & internegative film

| Company | Literal | Description |
|---|---|---|
| Agfa | ACRD | Agfa Agfachrome Duplication Film CRD |
| Fuji | FCDU | Fuji Fujichrome CDU Duplicating |
| | FCDU1 | Fuji Fujichrome CDU Duplicating, Type I |
| | FCDU2 | Fuji Fujichrome CDU Duplicating, Type |
| | | II |
| | FITN | Fuji Fujicolor Internegative IT-N |
| Kodak | K1571 | Kodak 1571 Internegative |
| | K2475RE | Kodak Recording Film 2475 |
| | K4111 | Kodak 4111 |
| | KC4125 | Kodak Professional Professional Copy |
| | | Film 4125 |
| | K6121 | Kodak 6121 |
| | KA2405 | Kodak Double-X Aerographic Film 2405 |
| | KA2422 | Kodak Aerographic Direct Duplicating |
| | | Film 2422 |
| | KA2447 | Kodak Aerochrome II Duplicating Film |
| | | 2447 |
| | KARA2425 | Kodak Aerographic RA Duplicating Film |
| | | 2425, ESTAR Base |
| | KARA4425 | Kodak Aerographic RA Duplicating Film |
| | | 4425, ESTAR Thick Base |
| | KARA | Kodak Aerographic RA Duplicating Film |
| | KCIN | Kodak Commercial Internegative Film |
| | KE5071 | Kodak Ektachrome Slide Duplicating |
| | | Film 5071 |
| | KE5072 | Kodak Ektachrome Slide Duplicating |
| | | Film 5072 |
| | KE6121 | Kodak Ektachrome Slide Duplicating |
| | | Film 6121 |
| | KE7121K | Kodak Ektachrome Duplicating Film |
| | | 7121, Type K |
| | KESO366 | Kodak Ektachrome SE Duplicating Film |
| | | SO-366 |
| | KS0279 | Kodak S0279 |
| | KS0366 | Kodak S0366 |
| | KSO132 | Kodak Professional B/W Duplicating |
| | | Film SO-132 |
| | KV4325 | Kodak Vericolor Internegative 4325 |
| | KVIN | Kodak Vericolor Internegative Film |
| Reserved | — | See Table 14 |

Referring to Table 19, Facsimile types and formats are illustrated. This listing is not meant as a limitation and is for illustrative purposes only.

TABLE 19
Facsimile

| Category | Literal | Description |
|---|---|---|
| Digital | — | See Table 21 |
| Facsimile | DFAXH | DigiBoard, DigiFAX Format, Hi-Res |
| | DFAXL | DigiBoard, DigiFAX Format, Normal-Res |
| | G1 | Group 1 Facsimile |
| | G2 | Group 2 Facsimile |
| | G3 | Group 3 Facsimile |
| | G32D | Group 3 Facsimile, 2D |
| | G4 | Group 4 Facsimile |
| | G42D | Group 4 Facsimile, 2D |
| | G5 | Group 4 Facsimile |
| | G52D | Group 4 Facsimile, 2D |
| | TIFFG3 | TIFF Group 3 Facsimile |
| | TIFFG3C | TIFF Group 3 Facsimile, CCITT RLE 1D |
| | TIFFG32D | TIFF Group 3 Facsimile, 2D |
| | TIFFG4 | TIFF Group 4 Facsimile |
| | TIFFG42D | TIFF Group 4 Facsimile, 2D |
| | TIFFG5 | TIFF Group 5 Facsimile |
| | TIFFG52 D | TIFF Group 5 Facsimile, 2D |
| Reserved | — | See Table 14 |

Referring to Table 20 (below) examples of the types of print paper that can be classified by the present invention are illustrated. Again, this list is for illustrative purposes only and is not meant as a limitation.

TABLE 20
Prints

| Company | Literal | Description |
|---|---|---|
| Agfa | ACR | Agfacolor RC |
| | ABF | Agfa Brovira, fiber, B&W |
| | ABSRC | Agfa Brovira-speed RC, B&W |
| | APF | Agfa Portriga, fiber, B&W |
| | APSRC | Agfa Portriga-speed RC, B&W |
| | ARRF | Agfa Record-rapid, fiber, B&W |
| | ACHD | Agfacolor HDC |
| | AMCC111FB | Agfacolor Multicontrast Classic MC C 111 FB, |
| | | double weight, glossy surface |
| | AMCC118FB | Agfacolor Multicontrast Classic MC C 118 FB, |
| | | double weight, fine grained matte surface |
| | AMCC1FB | Agfacolor Multicontrast Classic MC C 1 FB, single |
| | | weight, glossy surface |
| | AMCP310RC | Agfacolor Multicontrast Premium RC 310, glossy |
| | | surface |
| | AMCP312RC | Agfacolor Multicontrast Premium RC 312, semi-matte |
| | | surface |
| | APORG | Agfacolor Professional Portrait Paper, glossy surface |
| | | CN310 |
| | APORL | Agfacolor Professional Portrait Paper, semi-matte |
| | | surface CN312 |
| | APORM | Agfacolor Professional Portrait Paper, lustre surface |
| | | CN319 |
| | ASIGG | Agfacolor Professional Signum Paper, glossy surface |
| | | CN310 |
| | ASIGM | Agfacolor Professional Signum Paper, matte surface |
| | | CN312 |
| Konica | CCOL | Konica Color |
| Fuji | FCHP | Fujicolor HG Professional |
| | FCPI | Fujicolor Print |
| | FCSP | Fujicolor Super G Plus Print |
| | FCT35G | Fujichrome paper, Type 35, glossy surface |
| | FCT35HG | Fujichrome reversal copy paper, Type 35, glossy |
| | | surface |
| | FCT35HL | Fujichrome reversal copy paper, Type 35, lustre |
| | | surface |
| | FCT35HM | Fujichrome reversal copy paper, Type 35, matte |
| | | surface |
| | FCT35L | Fujichrome paper, Type 35, lustre surface |
| | FCT35M | Fujichrome paper, Type 35, matte surface |
| | FCT35PG | Fujichrome Type 35, polyester, super glossly surface |
| | FSFA5G | Fujicolor paper super FA, Type 5, glossy SFA5 |
| | | surface |
| | FSFA5L | Fujicolor paper super FA, Type 5, lustre SFA5 surface |
| | FSFA5M | Fujicolor paper super FA, Type 5, matte SFA5 surface |
| | FSFA5SG | Fujicolor paper super FA5, Type C, glossy surface |
| | FSFA5SL | Fujicolor paper super FA5, Type C, lustre surface |
| | FSFA5SM | Fujicolor paper super FA5, Type C, matte surface |
| | FSFA5SPG | Fujicolor paper super FA, Type 5P, glossy SFA P |
| | | surface |
| | FSFA5SPL | Fujicolor paper super FA, Type 5P, lustre SFA P |
| | | surface |
| | FSFA5SPM | Fujicolor paper super FA, Type 5P, matte SFA P |
| | | surface |
| | FSFAG | Fujicolor paper super FA, Type 5, glossy surface |
| | FSFAL | Fujicolor paper super FA, Type 5, lustre surface |
| | FSFAM | Fujicolor paper super FA, Type 5, matte surface |
| | FSFAS5PG | Fujicolor paper super FA, Type P, glossy SFA 5P |
| | | surface |
| | FSFAS5PL | Fujicolor paper super FA, Type P, lustre SFA 5P |
| | | surface |
| | FSFAS5PM | Fujicolor paper super FA, Type P, matte SFA 5P |
| | | surface |
| | FSFASCG | Fujicolor paper super FA, Type C, glossy surface |
| | FSFASCL | Fujicolor paper super FA, Type C, lustre surface |
| | FSFASCM | Fujicolor paper super FA, Type C, matte surface |
| | FTRSFA | Fujitrans super FA |
| | FXSFA | Fujiflex super FA polyester (super gloss), Fujiflex SFA |
| | | surface |
| Ilford | ICF1K | Ilfochrome Classic Deluxe Glossy Low Contrast |
| | ICLM1K | Ilfochrome Classic Deluxe Glossy Medium Contrast |
| | ICPM1M | Ilfochrome Classic RC Glossy |
| | ICPM44M | Ilfochrome Classic RC Pearl |
| | ICPS1K | Ilfochrome Classic Deluxe Glossy |
| | IGFB | Ilford Galerie FB |
| | IILRA1K | Ilfocolor Deluxe |
| | IIPRAM | Ilfocolor RC |
| | IMG1FDW | Ilford Multigrade Fiber, Double Weight |
| | IMG1FW | Ilford Multigrade Fiber Warmtone |
| | IMG1RCDLX | Ilford Multigrade RC DLX |
| | IMG1RCPDW | Ilford Multigrade RC Portfolio, Double Weight |
| | IMG1RCR | Ilford Multigrade RC Rapid |
| | IMG2FDW | Ilford Multigrade II Fiber, Double Weight |
| | IMG2FW | Ilford Multigrade II Fiber Warmtone |
| | IMG2RCDLX | Ilford Multigrade II RC DLX |
| | IMG2RCPDW | Ilford Multigrade II RC Portfolio, Double Weight |
| | IMG2RCR | Ilford Multigrade II RC Rapid |
| | IMG3FDW | Ilford Multigrade III Fiber, Double Weight |
| | IMG3FW | Ilford Multigrade III Fiber Warmtone |
| | IMG3RCDLX | Ilford Multigrade III RC DLX |
| | IMG3RCPDW | Ilford Multigrade III RC Portfolio, Double Weight |
| | IMG3RCR | Ilford Multigrade III RC Rapid |
| | IMG4FDW | Ilford Multigrade IV Fiber, Double Weight |
| | IMG4FW | Ilford Multigrade IV Fiber Warmtone |
| | IMG4RCDLX | Ilford Multigrade IV RC DLX |
| | IMG4RCPDW | Ilford Multigrade IV RC Portfolio, Double Weight |
| | IMGFSWG | Ilford Multigrade Fiber, Single Weight, glossy |
| | IPFP | Ilford PanF Plus |
| | ISRCD | Ilford Ilfospeed RC, Deluxe |
| Kodak | | B&W Selective Contrast Papers |
| | KPC1RCE | Kodak Polycontrast RC, medium weight, fine-grained, |
| | | lustre |
| | KPC1RCF | Kodak Polycontrast RC, medium weight, smooth, |
| | | glossy |
| | KPC1RCN | Kodak Polycontrast RC, medium weight, smooth, |
| | | semi-matte |
| | KPC2RCE | Kodak Polycontrast II RC, medium weight, fine- |
| | | grained, lustre |
| | KPC2RCF | Kodak Polycontrast II RC, medium weight, smooth, |
| | | glossy |
| | KPC2RCN | Kodak Polycontrast II RC, medium weight, smooth, |
| | | semi-matte |
| | KPC3RCE | Kodak Polycontrast III RC, medium weight, fine- |
| | | grained, lustre |
| | KPC3RCF | Kodak Polycontrast III RC, medium weight, smooth, |
| | | glossy |
| | KPC3RCN | Kodak Polycontrast III RC, medium weight, smooth, |
| | | semi-matte |
| | KPMFF | Kodak Polymax Fiber, single weight, smooth, glossy |
| | KPMFN | Kodak Polymax Fiber, single weight, smooth, semi- |
| | | matte |
| | KPMFE | Kodak Polymax Fiber, single weight, fine-grained, |
| | | lustre |
| | KPM1RCF | Kodak Polymax RC, single weight, smooth, glossy |
| | KPM1RCE | Kodak Polymax RC, single weight, fine-grained, lustre |
| | KPM1RCN | Kodak Polymax RC, single weight, smooth, semi-matte |
| | KPM2RCF | Kodak Polymax II RC, single weight, smooth, glossy |
| | KPM2RCE | Kodak Polymax II RC, single weight, fine-grained, |
| | | lustre |
| | KPM2RCN | Kodak Polymax II RC, single weight, smooth, semi- |
| | | matte |
| | KPMFAF | Kodak Polymax Fine-Art, double weight, smooth, |
| | | glossy |
| | KPMFAN | Kodak Polymax Fine-Art, double weight, smooth, |
| | | semi-matte |
| | KPPFM | Kodak Polyprint RC, medium weight, smooth, glossy |
| | KPPNM | Kodak Polyprint RC, medium weight, smooth, semi- |
| | | matte |
| | KPPEM | Kodak Polyprint RC, medium weight, fine-grained, |
| | | lustre |
| | KPFFS | Kodak Polyfiber, single weight, smooth, glossy |
| | KPFND | Kodak Polyfiber, double weight, smooth, semi-matte |
| | KPFGL | Kodak Polyfiber, light weight, smooth, lustre |
| | KPFNS | Kodak Polyfiber, smooth, single weight, semi-matte |
| | KPFND | Kodak Polyfiber, double weight, smooth, semi-matte |
| | KPFGD | Kodak Polyfiber, double weight, fine-grained, lustre |
| | | B&W Continuous Tone Papers |
| | KAZOF | Kodak AZO, fine-grained, lustre |
| | KB1RCF | Kodak Kodabrome RC Paper, smooth, glossy |
| | KB1RCG1 | Kodak Kodabrome RC, premium weight (extra heavy) |
| | | 1, fine-grained, lustre |
| | KB1RCN | Kodak Kodabrome RC Paper, smooth, semi-matte |
| | KB2RCF | Kodak Kodabrome II RC Paper, smooth, glossy |
| | KB2RCG1 | Kodak Kodabrome II RC, premium weight (extra |
| | | heavy) 1, fine-grained, lustre |
| | KB2RCN | Kodak Kodabrome II RC Paper, smooth, semi-matte |
| | KBR | Kodak Kodabromide, single weight, smooth, glossy |
| | KEKLG | Kodak Ektalure, double weight, fine-grained, lustre |
| | KEKMSCF | Kodak Ektamatic SC single weight, smooth, glossy |
| | KEKMSCN | Kodak Ektamatic SC, single weight, smooth, semi- |
| | | matte |
| | KEKMXRALF | Kodak Ektamax RA Professional L, smooth, glossy |
| | KEKMXRALN | Kodak Ektamax RA Professional L, smooth, semi- |
| | | matte |
| | KEKMXRAMF | Kodak Ektamax RA Professional M, smooth, glossy |
| | KEKMXRAMN | Kodak Ektamax RA Professional M, smooth, semi- |
| | | matte |
| | KELFA1 | Kodak Elite Fine-Art, premium weight (extra heavy) 1, |
| | | ultra-smooth, high-lustre |
| | KELFA2 | Kodak Elite Fine-Art, premium weight (extra heavy) 2, |
| | | ultra-smooth, high-lustre |
| | KELFA3 | Kodak Elite Fine-Art, premium weight (extra heavy) 3, |
| | | ultra-smooth, high-lustre |
| | KELFA4 | Kodak Elite Fine-Art, premium weight (extra heavy) 4, |
| | | ultra-smooth, high-lustre |
| | KK1RCG1 | Kodak Kodabrome RC, premium weight (extra heavy) |
| | | 1, fine-grained, lustre |
| | KK1RCG2 | Kodak Kodabrome RC, premium weight (extra heavy) |
| | | 2, fine-grained, lustre |
| | KK1RCG3 | Kodak Kodabrome RC, premium weight (extra heavy) |
| | | 3, fine-grained, lustre |
| | KK1RCG4 | Kodak Kodabrome RC, premium weight (extra heavy) |
| | | 4, fine-grained, lustre |
| | KK1RCG5 | Kodak Kodabrome RC, premium weight (extra heavy) |
| | | 5, fine-grained, lustre |
| | KK2RCG1 | Kodak Kodabrome II RC, premium weight (extra |
| | | heavy) 1, fine-grained, lustre |
| | KK2RCG2 | Kodak Kodabrome II RC, premium weight (extra |
| | | heavy) 2, fine-grained, lustre |
| | KK2RCG3 | Kodak Kodabrome II RC, premium weight (extra |
| | | heavy) 3, fine-grained, lustre |
| | KK2RCG4 | Kodak Kodabrome II RC, premium weight (extra |
| | | heavy) 4, fine-grained, lustre |
| | KK2RCG5 | Kodak Kodabrome II RC, premium weight (extra |
| | | heavy) 5, fine-grained, lustre |
| | KPMARCW1 | Kodak P-Max Art RC, double weight 1, suede double- |
| | | matte |
| | KPMARCW2 | Kodak P-Max Art RC, double weight 2, suede double- |
| | | matte |
| | KPMARCW3 | Kodak P-Max Art RC, double weight 3, suede double- |
| | | matte |
| | | B&W Panchromatic Papers |
| | KPSRCH | Kodak Panalure Select RC, H grade, medium weight, |
| | | smooth, glossy |
| | KPSRCL | Kodak Panalure Select RC, L grade, medium weight, |
| | | smooth, glossy |
| | KPSRCM | Kodak Panalure Select RC, M grade, medium weight, |
| | | smooth, glossy |
| | | Color Reversal Papers |
| | KER1F | Kodak Ektachrome Radiance Paper, smooth, glossy |
| | KER1N | Kodak Ektachrome Radiance Paper, smooth, semi- |
| | | matte |
| | KER1SF | Kodak Ektachrome Radiance Select Material, smooth, |
| | | glossy |
| | KER2F | Kodak Ektachrome Radiance II Paper, smooth, glossy |
| | KER2N | Kodak Ektachrome Radiance II Paper, smooth, semi- |
| | | matte |
| | KER2SF | Kodak Ektachrome Radiance II Select Material, |
| | | smooth, glossy |
| | KER3F | Kodak Ektachrome Radiance III Paper, smooth, |
| | | glossy |
| | KER3N | Kodak Ektachrome Radiance III Paper, smooth, semi- |
| | | matte |
| | KER3SF | Kodak Ektachrome Radiance III Select Material, |
| | | smooth, glossy |
| | KERCF | Kodak Ektachrome Radiance Copy Paper, smooth, |
| | | glossy |
| | KERCHCF | Kodak Ektachrome Radiance HC Copy Paper, |
| | | smooth, glossy |
| | KERCHCN | Kodak Ektachrome Radiance HC Copy Paper, |
| | | smooth, semi-matte |
| | KERCN | Kodak Ektachrome Radiance Copy Paper, smooth, |
| | | semi-matte |
| | KERCTF | Kodak Ektachrome Radiance Thin Copy Paper, |
| | | smooth, glossy |
| | KERCTN | Kodak Ektachrome Radiance Thin Copy Paper, |
| | | smooth, semi-matte |
| | KEROM | Kodak Ektachrome Radiance Overhead Material, |
| | | transparent ESTAR Thick Base |
| | | Color Negative Papers & Transparency Materials |
| | KD2976E | Kodak Digital Paper, Type 2976, fine-grained, lustre |
| | KD2976F | Kodak Digital Paper, Type 2976, smooth, glossy |
| | KD2976N | Kodak Digital Paper, Type 2976, smooth, semi-matte |
| | KDCRA | Kodak Duraclear RA Display Material, clear |
| | KDFRAF | Kodak Duraflex RA Print Material, smooth, glossy |
| | KDT2 | Kodak Duratrans Display Material, translucent |
| | KDTRA | Kodak Duratrans RA Display Material, translucent |
| | KECC | Kodak Ektacolor, Type C |
| | KECE | Kodak Ektacolor Professional Paper, fine-graned, |
| | | lustre |
| | KECF | Kodak Ektacolor Professional Paper, smooth, glossy |
| | KECN | Kodak Ektacolor Professional Paper, smooth, semi- |
| | | matte |
| | KEC | Kodak Ektacolor |
| | KEP2E | Kodak Ektacolor Portra II Paper, Type 2839, fine- |
| | | grained, lustre |
| | KEP2F | Kodak Ektacolor Portra II Paper, Type 2839, smooth, |
| | | glossy |
| | KEP2N | Kodak Ektacolor Portra II Paper, Type 2839, smooth, |
| | | semi-matte |
| | KEP3E | Kodak Ektacolor Portra III Paper, fine-grained, lustre |
| | KEP3F | Kodak Ektacolor Portra III Paper, smooth, glossy |
| | KEP3N | Kodak Ektacolor Portra III Paper, smooth, semi-matte |
| | KES2E | Kodak Ektacolor Supra II Paper, fine-grained, lustre |
| | KES2F | Kodak Ektacolor Supra II Paper, smooth, glossy |
| | KES2N | Kodak Ektacolor Supra II Paper, smooth, semi-matte |
| | KES3E | Kodak Ektacolor Supra III Paper, fine-grained, lustre |
| | KES3F | Kodak Ektacolor Supra III Paper, smooth, glossy |
| | KES3N | Kodak Ektacolor Supra III Paper, smooth, semi-matte |
| | KESE | Kodak Ektacolor Supra Paper, fine-grained, lustre |
| | KESF | Kodak Ektacolor Supra Paper, smooth, glossy |
| | KESN | Kodak Ektacolor Supra Paper, smooth, semi-matte |
| | KET1 | Kodak Ektatrans RA Display Material, smooth, semi- |
| | | matte |
| | KEU2E | Kodak Ektacolor Ultra II Paper, fine-grained, lustre |
| | KEU2F | Kodak Ektacolor Ultra II Paper, smooth, glossy |
| | KEU2N | Kodak Ektacolor Ultra II Paper, smooth, semi-matte |
| | KEU3E | Kodak Ektacolor Ultra III Paper, fine-grained, lustre |
| | KEU3F | Kodak Ektacolor Ultra III Paper, smooth, glossy |
| | KEU3N | Kodak Ektacolor Ultra III Paper, smooth, semi-matte |
| | KEUE | Kodak Ektacolor Ultra Paper, fine-grained, lustre |
| | KEUF | Kodak Ektacolor Ultra Paper, smooth, glossy |
| | KEUN | Kodak Ektacolor Ultra Paper, smooth, semi-matte |
| | | Inkjet Papers & Films |
| | KEJFC50HG | Kodak Ektajet 50 Clear Film LW4, Polyester Base, |
| | | clear |
| | KEJFEFSG | Kodak Ektajet Film, Type EF, semi-gloss |
| | KEJFLFSG | Kodak Ektajet Film, Type LF, semi-gloss |
| | KEJFW50HG | Kodak Ektajet 50 White Film, Polyester Base, high |
| | | gloss |
| | KEJP50SG | Kodak Ektajet 50 Paper, RC Base, semi-gloss |
| | KEJPC | Kodak Ektajet Coated Paper |
| | KEJPCHW | Kodak Ektajet Heavy Weight Coated Paper |
| | KEJPEFSG | Kodak Ektajet Paper, Type EF, semi-gloss |
| | KEJPLFSG | Kodak Ektajet Paper, Type LF, semi-gloss |
| Polaroid | POCP | OneFilm Color Print |
| | PPCP | Professional High Contrast Polychrome |
| | PPGH | Polagraph HC |
| | PPLB | Polablue BN |
| | PPPN | Polapan CT |
| Reserved | — | See Table 14 |

Referring to Table 21, the types of digital file formats that may be accommodated by the present invention are illustrated. This list is for illustrative purposes only and is not meant as a limitation.

TABLE 21
Digital

| Category | Literal | Description |
|---|---|---|
| Digital | ACAD | AutoCAD database or slide |
| | ASCI | ASCII graphics |
| | ATK | Andrew Toolkit raster object |
| | AVI | Microsoft video |
| | AVS | AVS X image |
| | BIO | Biorad confocal file |
| | BMP | Microsoft Windows bitmap image |
| | BMPM | Microsoft Windows bitmap image, monochrome |
| | BPGM | Bentleyized Portable Graymap Format |
| | BRUS | Doodle brush file |
| | CGM | CGM color |
| | CDR | Corel Draw |
| | CIF | CIF file format for VLSI |
| | CGOG | Compressed GraphOn graphics |
| | CMUW | CMU window manager bitmap |
| | CMX | Corel Vector |
| | CMYK | Raw cyan, magenta, yellow, and black bytes |
| | CQT | Cinepak Quicktime |
| | DVI | Typesetter DeVice Independent format |
| | EPS | Adobe Encapsulated PostScript |
| | EPSF | Adobe Encapsulated PostScript file format |
| | EPSI | Adobe Encapsulated PostScript Interchange format |
| | FIG | Xfig image format |
| | FIT | Flexible Image Transport System |
| | FLC | FLC movie file |
| | FLI | FLI movie file |
| | FST | Usenix FaceSaver(tm) file |
| | G10X | Gemini 10X printer graphics |
| | GEM | GEM image file |
| | GIF | CompuServe Graphics image |
| | GIF8 | CompuServe Graphics image (version 87a) |
| | GOUL | Gould scanner file |
| | GRA | Raw gray bytes |
| | HDF | Hierarchical Data Format |
| | HIPS | HIPS file |
| | HIS | Image Histogram |
| | HPLJ | Hewlett Packard LaserJet format |
| | HPPJ | Hewlett Packard PaintJet |
| | HTM | Hypertext Markup Language |
| | HTM2 | Hypertext Markup Language, version 2 |
| | HTM3 | Hypertext Markup Language, version 3 |
| | HTM4 | Hypertext Markup Language, version 4 |
| | ICON | Sun icon |
| | ICR | NCSA Telnet Interactive Color Raster |
| | | graphic format |
| | IFF | Electronic Arts |
| | ILBM | Amiga ILBM file |
| | IMG | Img-whatnot file |
| | JBG | Joint Bi-level image experts Group file |
| | | interchange format |
| | JPG | Joint Photographic experts Group file |
| | | interchange format |
| | LISP | Lisp Machine bitmap file |
| | MACP | Apple MacPaint file |
| | MAP | Colormap intensities and indices |
| | MAT | Raw matte bytes |
| | MCI | MCI format |
| | MGR | MGR bitmap |
| | MID | MID format |
| | MIF | ImageMagick format |
| | MITS | Mitsubishi S340-10 Color sublimation |
| | MMM | MMM move file |
| | MOV | Movie format |
| | MP2 | Motion Picture Experts Group (MPEG) |
| | | interchange format, level 2 |
| | MP3 | Motion Picture Experts Group (MPEG) |
| | | interchange format, level 3 |
| | MPG | Motion Picture Experts Group (MPEG) |
| | | interchange format, level 1 |
| | MSP | Microsoft Paint |
| | MTV | MTV ray tracer image |
| | NKN | Nikon format |
| | NUL | NULL image |
| | PBM | Portable BitMap |
| | PCD | Kodak Photo-CD |
| | PCX | ZSoft IBM PC Paintbrush |
| | PDF | Portable Document Format |
| | PGM | Portable GrayMap format |
| | PGN | Portable GrayMap format |
| | PI1 | Atari Degas .pi1 Format |
| | PI3 | Atari Degas .pi3 Format |
| | PIC | Apple Macintosh QuickDraw/PICT |
| | PLOT | Unix Plot(5) format |
| | PNG | Portable Network Graphics |
| | PNM | Portable anymap |
| | PPM | Portable pixmap |
| | PPT | Powerpoint |
| | PRT | PRT ray tracer image |
| | PS1 | Adobe PostScript, level 1 |
| | PS2 | Adobe PostScript, level 2 |
| | PSD | Adobe Photoshop |
| | QRT | QRT ray tracer |
| | RAD | Radiance image |
| | RAS | CMU raster image format |
| | RGB | Raw red, green, and blue bytes |
| | RGBA | Raw red, green, blue, and matte bytes |
| | RLE | Utah Run length encoded image |
| | SGI | Irix RGB image |
| | SIR | Solitaire file format |
| | SIXL | DEC sixel color format |
| | SLD | AutoCAD slide file |
| | SPC | Atari compressed Spectrum file |
| | SPOT | SPOT satelite images |
| | SUN | SUN Rasterfile |
| | TGA | Targa True Vision |
| | TIF | Tagged Image Format |
| | TIL | Tile image with a texture |
| | TXT | Raw text |
| | UIL | Motif UIL icon file |
| | UPC | Universal Product Code bitmap |
| | UYVY | YUV bit/pixel interleaved (AccomWSD) |
| | VIC | Video Image Communication And Retrieval |
| | | (VICAR) |
| | VID | Visual Image Directory |
| | VIF | Khoros Visualization image |
| | WRL | Virtual reality modeling language |
| | X1BM | X10 bitmap |
| | XBM | X11 bitmap |
| | XCC | Constant image of X server color |
| | XIM | XIM file |
| | XPM | X11 pixmap |
| | XWD | X Window system window Dump |
| | XXX | Image from X server screen |
| | YBM | Bennet Yee “face″ file |
| | YUV | Abekas YUY file |
| | YUV3 | Abekas Y- and U- and Y-file, 3 |
| | ZEIS | Zeiss confocal file |
| | ZINC | Zinc bitmap |
| Facsimile | — | See Table 19 |
| Reserved | — | See Table 14 |

Table 22 provides default software set root values. Implementations MAY add to, or extend values in Table 22.

TABLE 22
Software Sets

| | |
|---|---|
| 3C | Description |
| 3M | 3M |
| AD | Adobe |
| AG | AGFA |
| AIM | AIMS Labs |
| ALS | Alesis |
| APP | Apollo |
| APL | Apple |
| ARM | Art Media |
| ARL | Artel |
| AVM | AverMedia Technologies |
| ATT | AT&T |
| BR | Bronica |
| BOR | Borland |
| CN | Canon |
| CAS | Casio |
| CO | Contax |
| CR | Corel |
| DN | Deneba |
| DL | DeLorme |
| DI | Diamond |
| DG | Digital |
| DIG | Digitech |
| EP | Epson |
| FOS | Fostex |
| FU | Fuji |
| HAS | Hasselblad |
| HP | HP |
| HTI | Hitachi |
| IL | Iilford |
| IDX | IDX |
| IY | Iiyama |
| JVC | JVC |
| KDS | KDS |
| KK | Kodak |
| IBM | IBM |
| ING | Intergraph |
| LEI | Leica |
| LEX | Lexmark |
| LUC | Lucent |
| LOT | Lotus |
| MAM | Mamiya |
| MAC | Mackie |
| MAG | MAG Innovision |
| MAT | Matrox Graphics |
| MET | MetaCreations |
| MS | Microsoft |
| MT | Microtech |
| MK | Microtek |
| MIN | Minolta |
| MTS | Mitsubishi |
| MCX | Micrografx |
| NEC | NEC |
| NTS | Netscape |
| NTK | NewTek |
| NKN | Nikon |
| CN | Canon |
| PX | Pentax |
| OPC | Opcode |
| PNC | Pinnacle |
| PO | Polaroid |
| ROL | Roland |
| RO | Rollei |
| NS | Nixdorf-Siemens |
| OLY | Olympus |
| OR | O'Reilly |
| PAN | Panasonic |
| PRC | Princeton Graphics |
| QT | Quicktime |
| RIC | Ricoh |
| SAM | Samsung |
| SAN | SANYO |
| SHA | Sharp |
| SHI | Shin Ho |
| SK | Softkey |
| SN | Sony |
| SUN | SUN |
| TAS | Tascam |
| TE | TEAC |
| TKX | Tektronix |
| TOS | Toshiba |
| ULS | Ulead systems |
| UMX | UMAX |
| VWS | ViewSonic |
| VID | Videonics |
| WG | Wang |
| XX | Unknown |
| XE | Xerox |
| YA | Yashica |
| YAM | Yamaha |
| X | Unknown |
| . . . | etc. |

Table 23 (below) illustrates values for the “resolution ” filed. The resolution field behaves the way that the size field behaves. Table 23 provides specific examples of resolution by way of illustration only. This table is not meant as a limitation.

TABLE 23
Resolution examples

| | Literal | Dimension | Measure |
|---|---|---|---|
| Type 1 | 50S | 50 | ISO |
| | 200S | 200 | ISO |
| | 300DC | 600 | dpc |
| | 1200DI | 1200 | dpi |
| | . . . | . . . | etc. |
| Type 2 | 640 × 768P | 640 × 768 | pixels |
| | 1024 × 1280P | 1024 × 1280 | pixels |
| | 1280 × 1600P | 1024 × 1280 | pixels |
| | . . . | . . . | etc. |

Table 24 lists legal values for the stain field as might be used in chemical testing.

TABLE 24
Stain

| Literal | Description |
|---|---|
| 0 | Black & White |
| 1 | Gray scale |
| 2 | Color |
| 3 | RGB (Red, Green, Blue) |
| 4 | YIQ (RGB TV variant) |
| 5 | CYMK (Cyan, Yellow, Magenta, Black) |
| 6 | HSB (Hue, Sat, Bright) |
| 7 | CIE (Commission de l'Eclairage) |
| 8 | LAB |
| . . . | etc. |

Table 25 (below) lists legal values for the format field. Table 25 also identifies media dependences. For example, when format is ‘F’ the value of field media will be determined by Table 19.

TABLE 25
Format

| Literal | Description | Media |
|---|---|---|
| A | Audio-visual | unspecified |
| T | Transparency | Table 15 |
| N | Negative | Tables 16-18 |
| F | Facsimile | Table 19 |
| P | Print | Table 20 |
| C | Photocopy | Table 20 |
| D | Digital | Table 21 |
| V | Video | See Negative |
| . . . | etc. | etc. |

Referring now to FIG. 1 an overview of the present invention is illustrated. This figure provides the highest-level characterization of the invention. FIG. 1 itself represents all components and relations of the ASIA.

Reference conventions. Since FIG. 1 organizes all high-level discussion of the invention, this document introduces the following conventions of reference.

Whenever the text refers to “the invention” or to the “Automated System for Image Archiving”, it refers to the aggregate components and relations identified in FIG. 1.

Parenthesized numbers to the left of the image in FIG. 1 Invention represents layers of the invention. For example, ‘Formal specification’ represents the “first layer” of the invention.

In FIG. 1 Invention, each box is a hierarchically derived sub-component of the box above it. ‘ASIA’ is a sub-component of ‘Formal objects’, which is a sub-component of ‘Formal specification’. By implication, thus, ASIA is also hierarchically dependent upon ‘Formal specification.’ The following descriptions apply.

Formal specification 1. This represents (a) the formal specification governing the creation of systems of automatic image enumeration, and (b) all derived components and relations of the invention's implementation.

Formal objects 2. This represents implied or stated implementations of the invention.

ASIA 3. This is the invention's implementation software offering.

It is useful to discuss an overview of the present invention as a framework for the more detailed aspects of the invention that follow. Referring first to FIG. 1A an overview of the original image input process according to the present invention is shown. The user first inputs information to the system to provide information on location, author, and other record information. Alternatively, it is considered to be within the scope of the present invention for the equipment that the user is using to input the required information. In this manner, data is entered with minimum user interaction. This information will typically be in the format of the equipment doing the imaging. The system of the present invention simply converts the data via a configuration algorithm, to the form needed by the system for further processing. The encoding/decoding engine 12 receives the user input information, processes into, and determines the appropriate classification and archive information to be in coded 14. The system next creates the appropriate representation 16 of the input information and attaches the information to the image in question 18. Thereafter the final image is output 20, and comprises both the image data as well as the appropriate representation of the classification or archive information. Such archive information could be in electronic form seamlessly embedded in a digital image or such information could be in the form of a barcode or other graphical code that is printed together with the image on some form of hard copy medium.

Referring to FIG. 1B the operation of the system on an already existing image is described. The system first receives the image and reads the existing archival barcode information 30. This information is input to the encoding/decoding engine 32. New input information is provided 36 in order to update the classification and archival information concerning the image in question. This information will be provided in most cases without additional user intervention. Thereafter the encoding/decoding engine determines the contents of the original barcoded information and arrives at the appropriate encoded data and lineage information 34.

This data and lineage information is then used by the encoding/decoding engine to determine the new information that is to accompany the image 38 that is to be presented together with the image in question. Thereafter the system attaches the new information to the image 40 and outputs the new image together with the new image related information 42. In this fashion, the new image contains new image related information concerning new input data as well as lineage information of the image in question. Again, such archive information could be in electronic form as would be the case for a digital image or such information could be in the form of a barcode or other graphical code that is printed together with the image on some form of hard copy medium.

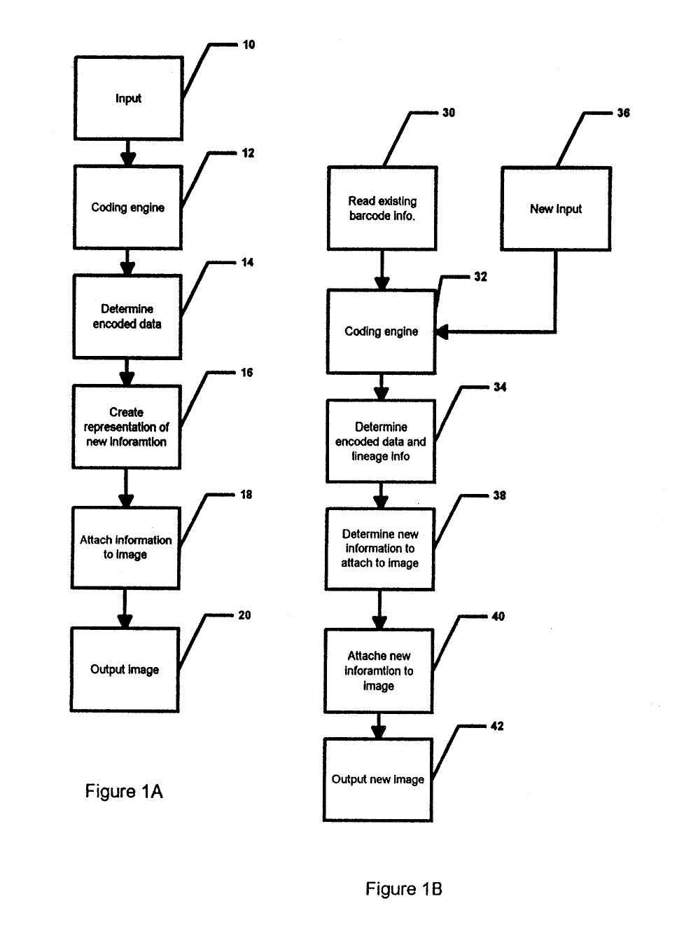

Referring to FIG. 2 the formal relations governing encoding 4, decoding 5, and implementation of the relations 6 are shown. Encoding and decoding are the operations needed to create and interpret the information on which the present invention relies. These operations in conjunction with the implementation of the generation of the lineage information give rise to the present invention. These elements are more fully explained below.

### Encoding

Introduction. This section specifies the formal relations characterizing all encoding of the invention, as identified in FIG. 2 Formal specification.

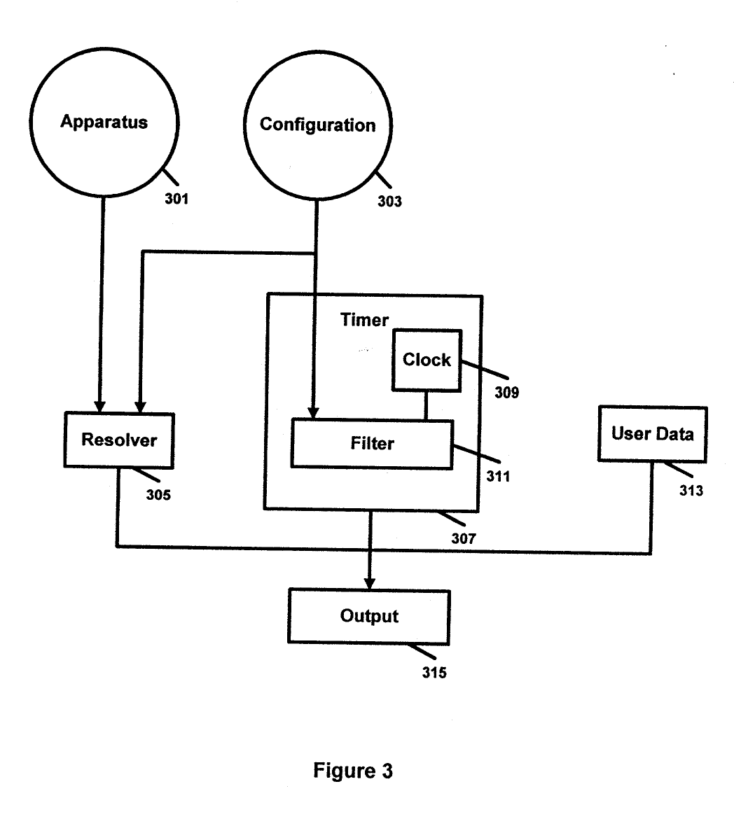

Rather than using a “decision tree” model (e.g., a flow chart), FIG. 3 uses an analog circuit diagram. Such a diagram implies the traversal of all paths, rather than discrete paths, which best describes the invention's, encoding relations.

Component descriptions. Descriptions of each component in FIG. 3 Encoding follow.

Apparatus input 301 generates raw, unprocessed image data, such as from devices or software. Apparatus input could be derived from image data, for example, the digital image from a scanner or the negative from a camera system.

Configuration input 303 specifies finite bounds that determine encoding processes, such as length definitions or syntax specifications.

The resolver 305 produces characterizations of images. It processes apparatus and configuration input, and produces values for variables required by the invention.

Using configuration input, the timer 307 produces time stamps. Time-stamping occurs in 2 parts:

The clock 309 generates time units from a mechanism. The filter 311 processes clock output according to specifications from the configuration input. Thus the filter creates the output of the clock in a particular format that can be used later in an automated fashion. Thus the output from the clock is passed through the filter to produce a time-stamp.

User data processing 313 processes user specified information such as author or device definitions, any other information that the user deems essential for identifying the image produced, or a set of features generally governing the production of images.

Output processing 315 is the aggregate processing that takes all of the information from the resolver, timer and user data and produces the final encoding that represents the image of interest.

### Decoding

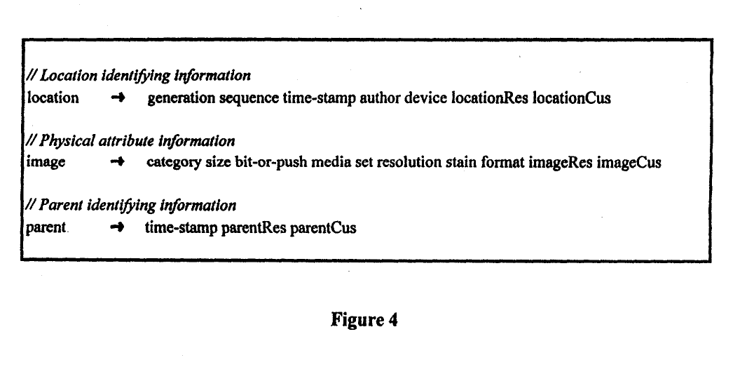

Referring to FIG. 4 the relationships that characterize all decoding of encoded information of the present invention are shown. The decoding scheme shown in FIG. 4 specifies the highest level abstraction of the formal grammar characterizing encoding. The set of possible numbers (the “language”) is specified to provide the greatest freedom for expressing characteristics of the image in question, ease of decoding, and compactness of representation. This set of numbers is a regular language (i.e., recognizable by a finite state machine) for maximal ease of implementations and computational speed. This language maximizes the invention's applicability for a variety of image forming, manipulation and production environments and hence its robustness.

Decoding has three parts: location, image, and parent. The “location” number expresses an identity for an image through use of the following variables.

| | |
|---|---|
| generation | Generation depth in tree structures. |
| sequence | Serial sequencing of collections or lots of images. |
| time-stamp | Date and time recording for chronological sequencing. |
| author | Creating agent. |
| device | Device differentiation, to name, identify, and distinguish |
| | currently used devices within logical space. |
| locationRes | Reserved storage for indeterminate future encoding. |
| locationCus | Reserved storage for indeterminate user customization. |

The “image” number expresses certain physical attributes of an image through the following variables.

| | |
|---|---|
| category | The manner of embodying or “fixing” a representation, |
| | e.g., “still” or “motion”. |
| size | Representation dimensionality. |
| bit-or-push | Bit depth (digital dynamic range) or push status of |
| | representation. |
| set | Organization corresponding to a collection of tabular |
| | specifiers, e.g. a “Hewlett Packard package of |
| | media tables”. |
| media | Physical media on which representation occurs. |
| resolution | Resolution of embodiment on media. |
| stain | Category of fixation-type onto media, e.g. “color”. |
| format | Physical form of image, e.g. facsimile, video, digital, etc. |
| imageRes | Reserved storage for indeterminate future encoding. |
| imageCus | Reserved storage for user customization. |

The “parent” number expresses predecessor image
identity through the following variables.

| | |
|---|---|
| time-stamp | Date, and time recording for chronological sequencing. |
| parentRes | Reserved storage, for indeterminate future encoding. |
| parentCus | Reserved storage, for indeterminate user customization. |

Any person creating an image using “location,” “image,” and “parent” numbers automatically constructs a representational space in which any image-object is uniquely identified, related to, and distinguished from, any other image-object in the constructed representational space.

### Implementation

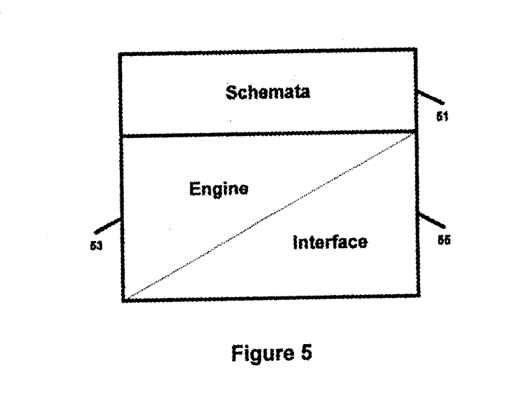

Referring to FIG. 5, the formal relations characterizing all implementations of the invention are shown. Three components and two primary relations characterize any implementation of the encoding and decoding components of the present invention. Several definitions of terms are apply.

“schemata” 51 are encoding rules and notations.

“engine ” 53 refers to the procedure or procedures for processing data specified in a schemata.

“interface” 55 refers to the structured mechanism for interacting with an engine.

The engine and interface have interdependent relations, and combined are hierarchically subordinate to schemata. The engine and interface are hierarchically dependent upon schemata.

### Formal Objects

The present invention supports the representation of (1) parent-child relations, (2) barcoding, and (3) encoding schemata. While these specific representations are supported, the description is not limited to these representations but may also be used broadly in other schemes of classification and means of graphically representing the classification data.

### Parent-child Implementation

Parent-child relations implement the ‘schemata’ and ‘engine’ components noted above. The following terms are used in conjunction with the parent child implementation of the present invention:

“conception date” means the creation date/time of image.

“originating image” means an image having no preceding conception date.

“tree” refers to all of the parent-child relations descending from an originating image.

“node” refers to any item in a tree.

“parent” means any predecessor node, for a given node.

“parent identifier” means an abbreviation identifying the conception date of an image's parent.

“child” means a descendent node, from a given node.

“lineage” means all of the relationships ascending from a given node, through parents, back to the originating image.

“family relations” means any set of lineage relations, or any set of nodal relations.

A conventional tree structure describes image relations.

### Encoding

Database software can trace parent-child information, but does not provide convenient, universal transmission of these relationships across all devices, media, and technologies that might be used to produce images that rely on such information. ASIA provides for transmission of parent-child information both (1) inside of electronic media, directly; and (2) across discrete media and devices, through barcoding.

This flexibility implies important implementational decisions involving time granularity and device production speed.

### Time Granularity & Number Collision

This invention identifies serial order of children (and thus parents) through date- and time-stamping. Since device production speeds for various image forming devices vary across applications, e.g. from seconds to microseconds, time granularity that is to be recorded must at least match device production speed. For example, a process that takes merely tenths of a second must be time stamped in at least tenths of a second.

In the present invention any component of an image forming system may read and use the time stamp of any other component. However, applications implementing time-stamping granularities that are slower than device production speeds may create output collisions, that is, two devices may produce identical numbers for different images. Consider an example in which multiple devices would process and reprocess a given image during a given month. If all devices used year-month stamping, they could reproduce the same numbers over and over again.

The present invention solves this problem by deferring decisions of time granularity to the implementation.

Implementation must use time granularity capable of capturing device output speed. Doing this eliminates all possible instances of the same number being generated to identify the image in question. In the present invention, it is recommended to use time intervals beginning at second granularity, however this is not meant to be a limitation but merely a starting point to assure definiteness to the encoding scheme. In certain operations, tenths of a second (or yet smaller units) may be more appropriate in order to match device production speed.

### Specification

All images have parents, except for the originating image which has a null ( ‘O’) parent. Parent information is recorded through (1) a generation depth identifier derivable from the generation field of the location number, and (2) a parent conception date, stored in the parent number. Two equations describe parent processing. The first equation generates a parent identifier for a given image and is shown below.

Equation 1: Parent identifiers. A given image's parent identifier is calculated by decrementing the location number's generation value (i.e. the generation value of the given image), and concatenating that value with the parent number's parent value. Equation 1 summarizes this:

parent identifier=prev(generation)•parent (1)

To illustrate parent-child encoding, consider an image identified in a given archive by the following key:

B0106-19960713T195913=JSA@1-19 S135F-OFCP@100S:2T-0123 19960613T121133

In this example the letter “B” refers to a second generation. The letter “C” would mean a third generation and so forth. The numbers “19960713” refers to the day and year of creation, in this case Jul. 13, 1996. The numbers following the “T” refers to the time of creation to a granularity of seconds, in this case 19:59:13 (using a 24 hour clock). The date and time for the production of the parent image on which the example image relies is 19960613T121133, or Jun. 13, 1996 at 12:11:33.

Equation 1 constructs the parent identifier:

parent identifier=prev(generation)•parent

or,

parent identifier=prev(B)•(19960613T121133)

=A•19960613T121133

=A19960613T121133

The location number identifies a B (or “2nd”) generation image. Decrementing this value identifies the parent to be from the A (or “1st”) generation. The parent number identifies the parent conception date and time, (19960613T121133). Combining these, yields the parent identifier A19960613T121133, which uniquely identifies the parent to be generation A, created on 13 Jun. 1996 at 12:11:13PM (T121133).

Equation 2 evaluates the number of characters needed to describe a given image lineage.

Equation 2: Lineage lengths. Equation 2 calculates the number of characters required to represent any given generation depth and is shown below:

$$\text{lineage} \text{length} = len ( key ) + \frac{( generation - 1 )}{( depth )} * \frac{len ( parent )}{( identifier )}$$

Example: 26 generations, 10⁷⁹ family relations. Providing a 26 generation depth requires a 1 character long definition for generation (i.e. A-Z). Providing 1000 possible transformations for each image requires millisecond time encoding, which in turn requires a 16 character long parent definition (i.e. gen. 1-digit, year-4 digit, month 2-digit, day 2-digit, hour 2-digit, min. 2-digit, milliseconds 3-digit). A 1 character long generation and 16 character long parent yield a 17 character long parent identifier.

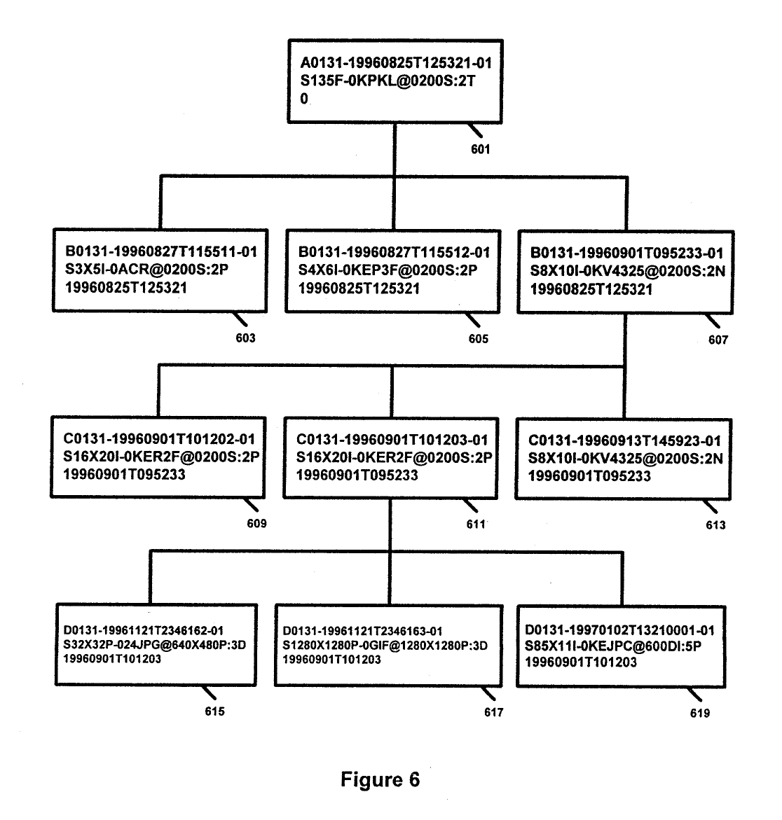

Referring to FIG. 6, the parent child encoding of the present invention is shown in an example form. The figure describes each node in the tree, illustrating the present invention's parent-child support.

601 is a 1^{st} generation original color transparency.

603 is a 2^{nd} generation 3×5 inch color print, made from parent 601.

605 is a 2^{nd} generation 4×6 inch color print, made from parent 601.

607 is a 2^{nd} generation 8×10 inch color internegative, made from parent 601.

609 is a 3^{rd} generation 16×20 inch color print, made from parent 607.

611 is a 3^{rd} generation 16×20 inch color print, 1 second after 609, made from parent 607.

613 is a 3^{rd} generation 8×10 inch color negative, made from parent 607.

615 is a 4^{th} generation computer 32×32 pixel RGB “thumbnail” (digital), made from parent 611.

617 is a 4^{th} generation computer 1280×1280 pixel RGB screen dump (digital), 1 millisecond after 615, made from parent 611.

619 is a 4^{th} generation 8.5×11 inch CYMK print, from parent 611.

This tree (FIG. 6) shows how date- and time-stamping of different granularities (e.g., nodes 601,615, and 617) distinguish images and mark parents. Thus, computer screen-dumps could use millisecond accuracy (e.g., 615,617), while a hand-held automatic camera might use second granularity (e.g., 601). Such variable date,- and time-stamping guarantees (a) unique enumeration and (b) seamless operation of multiple devices within the same archive.

### Processing Flow

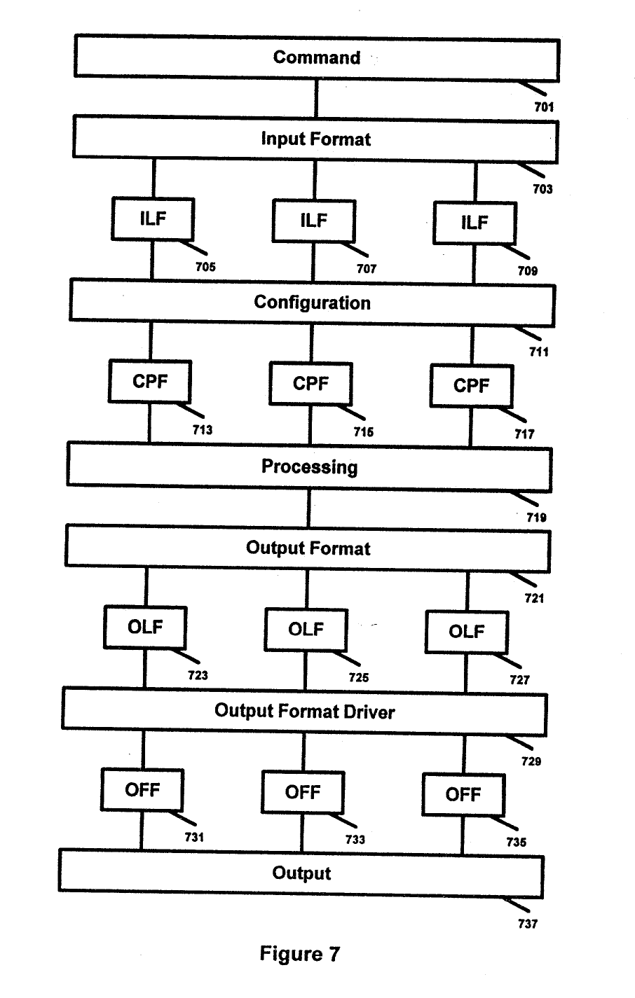

Referring to FIG. 7 the processing flow of ASIA is shown.

Command 701 is a function call that accesses the processing to be performed by ASIA Input format 703 is the data format arriving to ASIA. For example, data formats from Nikon, Hewlett Packard, Xerox, Kodak, etc., are input formats.

ILF (705,707, and 709) are the Input Language Filter libraries that process input formats into ASIA-specific format, for further processing. For example, an ILF might convert a Nikon file format into an ASIA processing format. ASIA supports an unlimited number of ILFs.

Configuration 711 applies configuration to ILF results. Configuration represents specifications for an application, such as length parameters, syntax specifications, names of component tables, etc.

CPF (713,715, and 717) are Configuration Processing Filters which are libraries that specify finite bounds for processing, such pre-processing instructions applicable to implementations of specific devices. ASIA supports an unlimited number of CPFs.

Processing 719 computes output, such as data converted into numbers.

Output format 721 is a structured output used to return processing results.

OLF (723, 725, 727) are Output Language Filters which are libraries that produce formatted output, such as barcode symbols, DBF, Excel, HTML, LATEX, tab delimited text, WordPerfect, etc. ASIA supports an unlimited number of OLFs.

Output format driver 729 produces and/or delivers data to an Output Format Filter.

OFF (731, 733, 735) are Output Format Filters which are libraries that organize content and presentation of output, such as outputting camera shooting data, database key numbers, data and database key numbers, data dumps, device supported options, decoded number values, etc. ASIA supports an unlimited number of OLFs.

### Applications

The design of parent-child encoding encompasses several specific applications. For example, such encoding can provide full lineage disclosure, and partial data disclosure.

Application 1: Full Lineage Disclosure, Partial Data Disclosure

Parent-child encoding compacts lineage information into parent identifiers. Parent identifiers disclose parent-child tracking data, but do not disclose other location or image data. In the following example a given lineage is described by (1) a fully specified key (location, image, and parent association), and (2) parent identifiers for all previous parents of the given key. Examples illustrates this design feature.

### Example 1: 26 Generations, 10⁷⁹ Family Relations

Providing a 26 generation depth requires a 1 character long definition for generation. Providing 1000 possible transformations for each image requires millisecond time encoding, which in turn requires a 16 character long parent definition. A 1 character long generation and 16 character long parent yield a 17 character long parent identifier (equation 1).

Documenting all possible family relations requires calculating the sum of all possible nodes. This is a geometric sum increasing by a factor of 1000 over 26 generations. The geometric sum is calculated by the following equation:

$$sum = \frac{{factor}^{( generation - 1 )} - 1}{factor - 1} or , \\ \begin{matrix}sum = \frac{{1000}^{( 26 - 1 )} - 1}{1000 - 1} \\ = \frac{{10}^{81} - 1}{999} \\ = 1.00 \cdot {10}^{79}\end{matrix} \qquad ( 3 )$$

For 26 generations, having 1000 transformations per image, the geometric sum yields 10⁷⁹ possible family relations. To evaluate the number of characters needed to represent a maximum lineage encoded at millisecond accuracy across 26 generations, the following equation is used (noted earlier):

$$lineage length = len ( key ) + \frac{( generation ) - 1}{( depth )} \cdot \frac{lens ( parent ) ( 2 )}{( identifier )} or$$

$$\begin{matrix}lineage length = ( 100 ) + ( 26 - 1 ) \cdot ( 17 ) \\ = 525\end{matrix}$$

Thus, the present invention uses 525 characters to encode the maximum lineage in an archive having 26 generations and 1000 possible transformations for each image, in a possible total of 10⁷⁹ family relations.

Example 2: 216 generations, 10⁶⁴⁹ family relations. The upper bound for current 2D symbologies (e.g., PDF417, Data Matrix, etc.) is approximately 4000 alphanumeric characters per symbol. The numbers used in this example illustrate, the density of information that can be encoded onto an internally sized 2D symbol.

Providing a 216 generation depth requires a 2 character long definition for generation. Providing 1000 possible transformations for each image requires millisecond time encoding, which in turn requires a 16 character long parent definition. A 2 character long generation and 16 character long parent yield an 18 character long parent identifier.

To evaluate the number of characters needed to represent a maximal lineage encoded at millisecond accuracy across 216 generations, we recall equation 2:

$$lineage length = len ( key ) + \frac{( generation ) - 1}{( depth )} \cdot \frac{lens ( parent ) ( 2 )}{( identifier )} or$$

$$\begin{matrix}lineage length = ( 100 ) + ( 216 - 1 ) \cdot ( 18 ) \\ = 3970\end{matrix}$$

In an archive having 216 generations and 1000 possible modifications for each image, a maximal lineage encoding requires 3970 characters.

Documenting all possible family relations requires calculating the sum of all possible nodes. This is a geometric sum increasing by a factor of 1000 over 216 generations. To calculate the geometric sum, we recall equation 3:

$$sum = \frac{{factor}^{( generation - 1 )} - 1}{factor - 1} or , \\ \begin{matrix}sum = \frac{{1000}^{( 216 - 1 )} - 1}{1000 - 1} \\ = \frac{{10}^{651} - 1}{999} \\ = 1.00 \cdot {10}^{649}\end{matrix}$$

For 216 generations, having 1000 transformations per image, the geometric sum yields 10⁶⁴¹ possible family relations. Thus, this invention uses 3970 characters to encode a maximal lineage, in an archive having 216 generations and 1000 possible transformations for each image, in a possible total of 10⁶⁴⁹ family relations.

Conclusion. The encoding design illustrated in Application 1:

Full lineage disclosure, partial data disclosure permits exact lineage tracking. Such tracking discloses full data for a given image, and parent identifier data for a given image's ascendent family. Such design protects proprietary information while providing full data recovery for any lineage by the proprietor.

A 216 generation depth is a practical maximum for 4000 character barcode symbols, and supports numbers large enough for most conceivable applications. Generation depth beyond 216 requires compression and/or additional barcodes or the use of multidimensional barcodes. Furthermore, site restrictions may be extended independently of the invention's apparati. Simple compression techniques, such as representing numbers with 128 characters rather than with 41 characters as currently done, will support 282 generation depth and 10⁸⁵⁰ possible relations.

### Application 2: Full Lineage Disclosure, Full Data Disclosure

In direct electronic data transmission, the encoding permits full transmission of all image information without restriction, of any archive size and generation depth. Using 2D+barcode symbologies, the encoding design permits full lineage tracking to a 40 generation depth in a single symbol, based on a 100 character key and a theoretical upper bound of 4000 alphanumeric characters per 2D symbol. Additional barcode symbols can be used when additional generation depth is needed.

### Application 3: Non-tree-structured Disclosure

The encoding scheme of the present invention has extensibility to support non-tree-structured, arbitrary descent relations. Such relations include images using multiple sources already present in the database, such as occurring in image overlays.

### Conclusion

Degrees of data disclosure. The invention's design supports degrees of data disclosure determined by the application requirements. In practicable measures the encoding supports:

1. Full and partial disclosure of image data;

2. Lineage tracking to any generation depth, using direct electronic data transmission;

3. Lineage tracking to restricted generation depth, using barcode symbologies, limited only by symbology size restrictions.

Further, ASIA supports parent-child tracking through time-stamped parent-child encoding. No encoding restrictions exist for electronic space. Physical boundaries within 2D symbology space promote theoretical encoding guidelines, although the numbers are sufficiently large so as to have little bearing on application of the invention. In all cases, the invention provides customizable degrees of data disclosure appropriate for application in commercial, industrial, scientific, medical, etc., domains.

### Barcoding Implementation

Introduction. The invention's encoding system supports archival and classifications schemes for all image-producing devices, some of which do not include direct electronic data transmission. Thus, this invention's design is optimized to support 1D-3D+barcode symbologies for data transmission across disparate media and technologies.

### 1D Symbology

Consumer applications may desire tracking and retrieval based on 1 dimensional (1D) linear symbologies, such as Code 39. Table 5 shows a configuration example which illustrates a plausible encoding configuration suitable for consumer applications.

The configuration characterized in Table 5 yields a maximal archive size of 989,901 images (or 19,798 images a year for 50 years), using a 4 digit sequence and 2 digit unit. This encoding creates 13 character keys and 15 character long, Code 39 compliant labels. A database holds full location, image, and parent number associations, and prints convenient location number labels, for which database queries can be made.

| | |
|---|---|
| <generation> = | 1 character |
| <sequence> = | 4 digits |
| <date> = | 6 digits |
| <unit> = | 2 digits |
| constants = | 2 characters |
| Total = | 15 characters |

### Table 5: Configuration Example

With such a configuration, a conventional 10 mil, Code 39 font, yields a 1.5 inch label. Such a label conveniently fits onto a 2×2 inch slide, 3×5 inch prints, etc. Note, that this encoding configuration supports records and parent-child relations through a conventional “database key” mechanism, not through barcode processing.

A system and method for automated coding of objects of different types has been disclosed. It will be appreciated by those skilled in the art that the present invention can find use in a wide variety of applications. The fact that various tables have been disclosed relating to images and image forming mechanisms should not be read as a limitation, but is presented by way of example only. Other objects such as software, databases, and other types of aggregations of information can equally take advantage of the present invention.

I claim:

1. A system for universal object tracking comprising:
an object forming apparatus;
a CPU integral to the image forming apparatus;
user input means connected to the CPU for receiving user input;
logic stored in the CPU for receiving user input and creating archive data based upon the user input; and
a graphic code producer responsive to the CPU for producing graphic codes representative of the archive data.

2. The system for universal object tracking of claim 1 wherein the object forming apparatus is taken from the group consisting of imaging forming apparatus, digital data forming apparatus, electronic data forming apparatus.

3. The system for universal object tracking of claim 1 wherein the object forming apparatus is a digital camera.

4. The system for universal object tracking of claim 1 wherein the object forming apparatus is a video camera.

5. The system for universal object tracking of claim 1 wherein the object forming apparatus is a digital image processor.

6. The system for universal object tracking of claim 1 wherein the object forming apparatus is a medical image sensor.

7. The system for universal object tracking of claim 6 wherein the medical image sensor is a magnetic resonance imager.

8. The system for universal object tracking of claim 6 wherein the medical image sensor is an X-ray imager.

9. The system for universal object tracking of claim 6 wherein the medical image sensor is a CAT scan imager.

10. The system for universal object tracking of claim 1 wherein the user input means is a push button input.

11. The system for universal object tracking of claim 1 wherein the user input means is a keyboard.

12. The system for universal object tracking of claim 1 wherein the user input means is voice recognition equipment.

13. The system for universal object tracking of claim 1 wherein the graphic codes are one-dimensional.

14. The system for universal object tracking of claim 1 wherein the graphic codes are two-dimensional.

15. The system for universal object tracking of claim 1 wherein the graphic codes are three-dimensional.

16. The system for universal object tracking of claim 1 wherein the logic comprises configuration input processing for determining bounds for the archive data generation based on configuration input;
a resolver for determining the correct value of archive data representing the image forming apparatus and the configuration input; and a timer for creating date/time stamps.

17. The system for universal object tracking of claim 16 wherein the timer further comprises a filter for processing the time stamp according to configuration input rules.

18. The system for universal object tracking of claim 16 wherein the configuration input comprises at least generation, sequence, data, unit, and constants information.

19. The system for universal object tracking of claim 1 further comprising a graphic code reader connected to the CPU for reading a graphic code on an image representing archive information; and
A decoder for decoding the archive information represented by the graphic code.

20. The system for universal object tracking of claim 19 wherein the logic further comprises:
logic for receiving a second user input and creating lineage archive information relating to the image based upon the archive information and the second user input;
and
logic for producing graphic code representative of the lineage archive data.

21. The system for universal object tracking of claim 1 wherein the archive data comprises location attributes of an image.

22. The system for universal object tracking of claim 1 wherein the archive data comprises physical attribute of an image.

23. The system for universal object tracking of claim 1 wherein each image in an image archive has unique archive data associated with each image.

24. The system for universal object tracking of claim 21 wherein the location data comprises at least:
image generation depth;
serial sequence of lot within an archive;
serial sequence of unit within a lot;
date location of a lot within an archive;
date location of an image within an archive;
author of the image; and
device producing the image.

25. The system for universal object tracking of claim 16 wherein the timer tracks year in the range of from 0000 to 9999.

26. The system for universal object tracking of claim 16 wherein the timer tracks all 12 months of the year.

27. The system for universal object tracking of claim 16 wherein the timer tracks time in at least hours and minutes.

28. The system for universal object tracking of claim 16 wherein the timer tracks time in fractions of a second.

29. The system for universal object tracking of claim 16 wherein the system is ISO 8601:1988 compliant.

30. The system for universal object tracking of claim 22 wherein the physical attributes comprise at least:
image category;
image size;
push status;
digital dynamic range;
image medium;
image resolution;
image stain; and
image format.

31. The system for universal object tracking of claim 20 wherein the lineage archive information comprises a parent number.

32. The system for universal object tracking of claim 31 wherein the parent number comprises at least:
a parent conception date; and
a parent conception time.

33. A method for universally tracking objects comprising:
inputting raw object data to an object forming apparatus; inputting object-related data;
creating first archive data based upon the object-related data; and translating the first archive data into a form that can be attached to the raw object data.

34. The method for universally tracking objects of claim 33 wherein the raw object data is from a film based camera.

35. The method for universally tracking objects of claim 33 wherein the raw object data is from a digital camera.

36. The method for universally tracking objects of claim 33 wherein the raw object data is from a video camera.

37. The method for universally tracking objects of claim 33 wherein the raw object data is from a digital image processor.

38. The method for universally tracking objects of claim 33 wherein the raw object data is from a medical image sensor.

39. The method for universally tracking objects of claim 38 wherein the medical object sensor is a magnetic resonance imager.

40. The method for universally tracking objects of claim 38 wherein the raw object data is from an X-ray imager.

41. The method for universally tracking objects of claim 38 wherein the raw object data is from a CAT scan imager.

42. The method for universally tracking objects of claim 33 wherein the inputting object related data occurs without user intervention.

43. The method for universally tracking objects of claim 33 wherein the inputting of object related data occurs via push button input.

44. The method for universally tracking objects of claim 33 wherein the inputting of object related data occurs via voice recognition equipment.

45. The method for universally tracking objects of claim 33 wherein the inputting of object related data occurs via a keyboard.

46. The method for universally tracking objects of claim 33 wherein the form of the translated archive data is an electronic file.

47. The method for universally tracking objects of claim 33 wherein the form of the translated data is a graphic code.

48. The method for universally tracking objects of claim 47 wherein the graphic code is one dimensional.

49. The method for universally tracking objects of claim 47 wherein the graphic code is two dimensional.

50. The method for universally tracking objects of claim 47 wherein the graphic code is three dimensional.

51. The method for universally tracking objects of claim 33 wherein the object data comprises image data and second archive data.

52. The method for universally tracking objects of claim 33 further comprising reading4 the second archive data; and creating lineage archive information relating to the object based upon the first archive information and second archive information.

53. The method for universally tracking objects of claim 33 wherein the inputting of object related data comprises configuration input processing for determining bounds for the archive data generation based upon configured input;
determining the correct value of archive data representing the object forming apparatus and configuration input; and date/time s tamping the object related data.

54. The method for universally tracking objects of claim 53 wherein date/time stamping is filtered according to configuration input rules.

55. The method for universally tracking objects of claim 33 wherein the configuration input comprises at least generation, sequence, data, unit, and constants information.

56. The method for universally tracking objects of claim 33 wherein the first archive data comprises location attributes of an object.

57. The method for universally tracking objects of claim 33 wherein the first archive data comprises physical attributes of an object.

58. The method for universally tracking objects of claim 56 wherein the location attributes comprise at least:
object generation depth;
serial sequence of lot within an archive;
serial sequence of unit within a lot;
date location of a lot within an archive;
date location of an object within an archive;
author of the object; and
device producing the object.

59. The method for universally tracking objects of claim 57 wherein the physical attributes of an object comprise at least:
object category;
image size;
push status;
digital dynamic range;
image medium;
software set;
image resolution;
image stain; and
image format.

60. The method for universally tracking objects of claim 52 wherein the lineage archive information comprises a parent number.

61. The method for universally tracking objects of claim 52 wherein the parent number comprises at least:
a parent conception date; and
a parent conception time.

62. The system for universal object tracking of claim 1 wherein the input means comprises a magnetic card reader.

63. The system for universal object tracking of claim 1 wherein the input means comprises a laser scanner.

64. The system for universal object tracking of claim 31 wherein the physical attributes further comprise;
imageRes; and
imageCus.

65. The method for universally tracking objects of claim 33 wherein the inputting object related data is via a magnetic card reader.

66. The method for universally tracking objects of claim 33 wherein the inputting of object related data is via a laser scanner.

67. The method of universally tracking objects of claim 33 wherein the inputting of object related data is via an optical reader.
